(19) United States
(12) Patent Application Publication
(10) Pub. No.: US 2020/0065853 A1
(43) Pub. Date: Feb. 27, 2020

(54) Video-Tournament Platform

(71) Applicant: ChannelFix.com LLC, Minden, NV (US)

(72) Inventor: John Graham Cvinar, West Chester, PA (US)

(21) Appl. No.: 16/667,225

(22) Filed: Oct. 29, 2019

Related U.S. Application Data
(63) Continuation of application No. PCT/US2018/025336, filed on Mar. 30, 2018.
(60) Provisional application No. 62/504,666, filed on May 11, 2017.
(60) Provisional application No. 62/529,750, filed on Jul. 7, 2017.
(60) Provisional application No. 62/567,699, filed on Oct. 3, 2017.

(51) Int. Cl. G06Q 30/02; G06Q 50/00

(52) U.S. Cl. CPC G06Q 30/0245; G06Q 30/0243; G06Q 50/01; G06Q 30/0273; G06Q 30/0276

(57) ABSTRACT

A method for conducting a tournament includes activating a competition, receiving video submissions from a plurality of content providers, and transmitting a compensation amount to at least a subset of the content providers, each having provided an acceptable video submission. The acceptable video submissions are assigned a seed-position and published based on the assigned seed positions to a plurality of voters. A winning content provider is determined based at least in part on votes received, and a prize is transmitted to the winning content provider. The compensation amount provided to each of the content providers obviates the prize from being construed as a lottery. The method can further include gaming-avoidance and anti-fraud features. League structures can be created to increase user retention and add relevancy of each competition to a user's continued experience on the platform.

### RELATED APPLICATIONS

This application is a Continuation of International Application No. PCT/US2018/025336, filed Mar. 30, 2018, which claims the benefit of U.S. Application No. 62/504,666, filed May 11, 2017, U.S. Application No. 62/529,750, filed Jul. 7, 2017, and U.S. Application No. 62/567,699, filed Oct. 3, 2017. The entire teachings of the above applications are incorporated herein by reference.

### BACKGROUND

Streaming video is increasing in popularity among brands and content creators as a means for reaching the public. As streaming technologies become more efficient, users of networked devices are finding that video is a convenient and enjoyable means by which to consume information or provide entertainment. Several news websites and social-media sites routinely provide video content in addition to other media formats, such as text articles and podcasts. Also, website advertisements now often include video content instead of, or in addition to, static images and text. As the consumption of video content increases with the viewing public, there is an increasing demand for the creation of video content and platforms for distributing video content.

### SUMMARY OF THE INVENTION

Methods and systems of the present invention provide for presenting video content to a plurality of users, including establishing a real time connection (RTC) from content providers to voters. A video player suitable for use in video tournaments presents video content from at least two competing providers, the video content being formatted for simultaneous and adjustable viewing by voters. Methods and systems of the present invention can also be used to provide a tournament platform in which competing video submissions are received, organized, and presented to a viewing audience for voting. The tournament platform can include compensation mechanisms to prevent a tournament from being construed as a lottery. The compensation mechanisms can also include an on-platform currency or other compensation system to charge user participation fees and allow wagering that would not be considered illegal gambling. The tournament platform can further serve as an intermediary for content providers and sponsors wishing to host themed video-submission contests, optionally charging sponsors to approve submissions from content providers to populate a contest. Sponsors can also use the tournament platform to offer themes that stimulate content providers and users to provide market research information, advertising, and promotion of products or brands. The platform can further provide for e-leagues, allowing netizens to upload and compete with user-generated videos in contests for global ranking and prizes in a structured environment, further providing for organization of increasing amounts of video uploads. The tournament platform can also provide an advertising portal, with on-platform actions providing revenue-generating activity for the platform and increased engagement for Sponsors. The tournament can also operate as a social platform for “closed” groups of contacts to perform contests among themselves.

A method of presenting video content includes establishing a real time connection (RTC) between a plurality of users, including at least one content provider and at least one voter. A session description from each of the participating users, including the at least one content provider at the least one voter, is obtained and sent to one another through a signaling server, then used to establish the real time connection between them. The method can alternatively, or further, include establishing an RTC between at least two content providers and at least one voter allowing a parallel stream of live video feeds. The type of RTC can be determined based upon a number of participating users, including content providers and voters. For example, in challenge battles or closed tournaments in which a limited number of content providers and voters are participating, the RTC type can be a peer-to-peer connection. Alternatively, for large numbers of participating users, a relayed connection can be used, with a relay server through which the video streams are relayed. The latter allows for processing of the live video streams, for example, archiving and playback. Alternatively, the TRC type can be a relayed connection, such as by a relay server.

Another method of presenting video content includes receiving video content from at least two content providers of a tournament platform and dynamically rendering the received video content in a juxtapose module. The juxtapose module includes a separator element configured to slidably reveal a first media element while hiding a second media element and vice versa. The method further includes streaming the dynamically rendered video content to a plurality of voters of the tournament platform. The received video content may include sound, and the method can further include adjusting a volume of the first or second video media element based upon a position of the separator element. The separator element can be automatically adjusted upon end of playback of one or both of the video media elements to, for example, display more or less of either of the media elements.

A method of providing a tournament platform in a network includes using a processor to perform the steps of activating a competition, receiving video submissions, including live video feeds, from a plurality of content providers, and transmitting a compensation amount to at least a subset of the content providers. The activation of a competition includes publishing a basis for the competition and criteria for acceptance of video submissions for the competition. The subset of content providers includes those providers having provided an acceptable video submission. The method further includes publishing the acceptable video submissions to a plurality of voters and receiving votes from the plurality of voters. A winning content provider is determined based, at least in part, on the received votes, and an award is transmitted to the winning content provider.

Optionally, an activation request can be received from a sponsor, the activation request including the basis for the competition and the criteria for acceptance of video submissions. The activation of a competition can include charging the sponsor for initiation of the contest and/or charging the sponsor a fee per video submission. The method can further include assigning a seed-position to each of the acceptable video submissions and publishing the acceptable video submissions on the tournament platform based on the assigned seed-positions. Additionally, the method can include providing, calculating, or generating a unique score to each of the acceptable video submissions and publishing the acceptable video submissions on the tournament platform based on the score to determine initial seed-positions. Alternatively, the method can include ranking the acceptable video submissions by popular vote, which can allow for the ranking of video submissions to be changing as voting occurs. The assigned seed positions of each of at least a subset of the acceptable video submissions can be determined based on the video submission ranking, which can, in turn, be based on assigned seed-positions, scoring, popular vote, or any combination thereof. In addition, or alternatively, a second subset of content providers can be designated based on the ranking of each of the acceptable video submissions, and second video submissions can be received from such content providers. The published acceptable video submissions can then be the second video submissions. This process can iterate multiple times for third, fourth, fifth, etc. acceptable video submissions.

The method can further include displaying the plurality of received video submissions to a sponsor and receiving from the sponsor an acceptance indicator or a rejection indicator for each of the received video submissions. Acceptable video submissions, for which a compensation amount, or fee for service, is optionally transmitted, can be limited to those video submissions having received an acceptance indicator. The compensation amount can be published during activation of the competition. A sponsor fee can be obtained upon activation of a competition, upon receipt of each acceptable video submission, or both.

In addition to votes, the determination of a winning content provider can further be based on provider review, sponsor review, or a combination thereof. The weight of each party's impact on the determination of a winning content provider can vary, providing diverse configurations of voting-mechanics for each specific contest. Content providers can be organized based on provider metrics, such as, for example, a number of submitted videos, number of winning videos, percentage of submitted videos having won a competition, percentage of winning videos across several competitions originating from the provider, number of competitions entered, average votes per submitted video, age, gender, interests in specific categories of previous on-platform-contests, interests in previous categories based on previous voting patterns or history, geographical location, geographical-proximity to specific locations, events, or surroundings, and the like. A content-provider listing can be displayed to a sponsor and provider metrics can determine varying acceptance costs from specific content providers. Participation invitations can be transmitted to sponsor-selected content providers for the competition.

The activation of a competition can further include the publication of at least one prerequisite requirement for content providers. The verification of the prerequisite requirement having been met can occur before or during the assigning of a seed-position to each of the acceptable video submissions. The prerequisite requirement can be, for example, a provider metric, a sponsor metric, proof of purchase of an item, proof of existing ownership of an item, proof of attendance at a virtual or physical event, identity confirmation, entry of invitation code, an entry cost of electronic currency, an entry cost of on-platform currency, and an entry cost of an on-platform rewards program that is given to the content provider or gained by the content provider through experiential participation on the platform, or any combination thereof.

The method can further include assigning a weighting structure for the competition, the weighting structure including values for each of a sponsor weight, a tournament provider weight, and a voting weight. The weighting structure values can be received from a sponsor. The determination of a winning content provider can further be based on sponsor feedback, tournament provider feedback, or both. The compensation amount and the award can be an amount of currency, remittance for goods, remittance for services, awarding of electronic currency, awarding of on-platform currency, or awarding of a digital award, acceptance into exclusive contests, or any combination thereof.

The method can also include presenting a voter with an option to purchase a supervote. Users can also be provided with tiered voting privileges based on user verification requirements. For example, users may be automatically entered into a first tier of voting privileges with a limited number of votes until such users complete a basic user verification step, such as verifying a cell phone number. As a further example, users that have completed a basic verification step can then be entered into a second tier of voting privileges with a limited number of votes until a second user verification requirement is met. User verification requirements can include verified user contact information, verified identifying indicia in a video submission, facial recognition, or any combination thereof. Voter identities can also undergo user verification prior to being permitted to vote in any competition. Content providers can also undergo user verification prior to being permitted to enter content in any competition.

Optionally, an advertisement may be placed at or near a voting button, such that upon receipt of a vote from a user, an advertising click is registered or caused to be registered. Alternatively, or in addition, upon clicking a vote button, a user may be routed to a third-party or sponsor website. In yet another alternative, the advertisement can be a pre-vote requirement in order to proceed and complete an actual vote.

A system for providing a tournament platform in a network includes a processor configured to activate a competition on a tournament platform, receive video submissions from a plurality of content providers, and transmit a compensation amount to at least a subset of the content providers. The activation of a competition includes publishing a basis for the competition and criteria for acceptance of video submissions for the competition. The subset of content providers includes those providers having provided an acceptable video submission. The processor is further configured to assign a seed-position to each of the acceptable video submissions, publish the acceptable video submissions on the tournament platform based on the assigned seed-positions to a plurality of voters, and receive votes from the plurality of voters. A winning content provider is determined based, at least in part, on the received votes, and an award is transmitted to the winning content provider. Additionally, the processor can be further configured to optionally charge an entry fee from on-platform-currency that was previously accumulated by the content provider. The video submissions can be live stream video submissions and the processor can be further configured to relay live video streams from the plurality of users.

A method of conducting a video competition includes receiving a challenge request from each of at least two content providers and activating a challenge competition, including publishing a theme for the challenge to the at least two content providers. The method further includes receiving video submissions from the at least two content providers and relaying the received video submissions from the at least two content providers to a plurality of voters, the received video submissions simultaneously presenting to the plurality of voters. Votes are received form the plurality of voters and a winning content provider is determined based on the received votes.

A system for providing a video comparison platform in a network includes a processor configured to receive a challenge request from each of at least two content providers and activate a challenge competition, including publishing a theme for the challenge to the at least two content providers. The processor can be further configured to receive video submissions from the at least two content providers and relay the received video submissions from the at least two content providers to a plurality of voters, the received video submissions simultaneously presenting to the plurality of voters.

The video submissions can be live streaming videos. Relaying the received video submissions includes establishing real time connections (RTC) between the at least two content providers and the plurality of voters. A media stream comprising the received video submissions can be transmitted directly from the at least two content providers to the plurality of voters. Alternatively, a media stream comprising the received video submissions can be relayed through a server from at least two content providers to the plurality of voters. The received video submissions can be displayed to a reviewer, and an acceptance indicator or a rejection indicator for each of the received video submissions can be received.

Video contests can be initiated by users, brands, or by the platform. In some embodiments, anyone can upload their video entry to compete for free. Viewers can vote to determine the winners of prestigious prizes exclusively through the platform. In a tournament, a large number of video submissions from several users can ultimately boil down to top-influencers competing against other top influencers, with success determined by both public voting and quality judging by a brand Sponsor and/or the platform. A tournament can have any type of prize (e.g., physical prizes, virtual items, e-delivered prizes, invitation to exclusive contests, or cash). Within the platform there can be a Leaderboard that gives continued purpose to involvement on the platform, creating incentive to stay active and quality for exclusive “invitational” contests. Through customization available to sponsors for sponsor-created contests, a contest can range from, for example, two users engaged in a one-hour “Challenge Battle” for a nominal prize (e.g., $2 in cash or tokens) to unlimited participants engaged in a months-long “Tournament” for high-value prizes (e.g., $200 goods). In Challenge Battles, users can “wager” winnings versus one another in a competitive and addictive style and in a manner that prevents the battle from being construed as gambling. In a “Social Battle,” a type of user-initiated contest, a group of friends can conduct a closed tournament in which participation is limited to invited users, such as through a unique URL or direct-messaging. For example, in a Social Battle, a user can create a customized theme of his/her choosing and can exclusively invite specific people, or allow participation based on access to a specific custom URL so that the video contest is limited to a private group of individuals. In contests and battles involving live-streaming, more than one theme can be included, with the changing themes being broadcast to content providers as they stream a video in real time.

In addition, tournament platforms of the present invention can provide for viral video campaign contests. A contest can become a battle of content creators through user-generated-content that brands find valuable in researching markets, promoting, and/or advertising brands or products. For example, viral viewership of a contest (e.g., a tournament or a battle) engaged in by content providers and other users, including, in particular, influencers, can bring considerable traffic to the tournament platform. As users are introduced and want to support videos they enjoy, vote requirements can provide for a brand to meet marketing objectives (e.g., a vote click results in a redirect to a sponsored site). Viral-attention among users of the platform to tournament can also thus be converted into revenue for both the platform (e.g., charging for clicks) and the sponsor (e.g., users landing on their chosen URL upon voting). With active revenue-models already created, the platform can also stand as a marketing platform.

Systems and methods can further include activation of a pre-competition crowd-fund and receipt of donations from a plurality of users. Upon closure of the crowd-fund, a competition may be launched, with the award for a competition being at least a portion of the donations.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a diagram illustrating user relationships in an embodiment of a tournament platform.

FIG. 1B is a diagram illustrating tournament components in an embodiment of a tournament platform.

FIG. 2 is a flowchart illustrating a method of providing a tournament platform in a network.

FIG. 3 is a diagram illustrating an example of a tournament weighting structure.

FIG. 4A is a diagram illustrating an example of a tournament seeding structure.

FIG. 4B is a diagram illustrating an example of a tournament competition.

FIG. 5 is a diagram illustrating an example of a user interface.

FIG. 6 is a schematic view of a computer network environment in which embodiments of the present invention may be deployed.

FIG. 7 is a block diagram of computer nodes or devices in the computer network of FIG. 6.

FIG. 8 is a diagram illustrating a video upload interface.

FIG. 9 is a diagram illustrating an example of acceptance/rejection of a video entry.

FIG. 10 is a diagram illustrating an example of a ranking stage.

FIG. 11 is a diagram illustrating an example of a battle stage.

FIG. 12 is a diagram illustrating an example of a battle stage prompt.

FIG. 13 is a diagram illustrating an example of a multi-entry tournament prompt.

FIG. 14A is a diagram illustrating an example of a challenge battle prompt.

FIG. 14B is diagram illustrating another example of a challenge battle prompt.

FIG. 15 is a diagram illustrating an example of a first voting prompt.

FIG. 16 is a diagram illustrating an example of second voting prompt with a supervote option.

FIG. 17 is a diagram illustrating an example of a user verification stage.

FIG. 18 is a diagram illustrating an example of a sponsor review prompt.

FIG. 19 is a diagram illustrating an example of a sponsor advertisement management prompt.

FIG. 20 is a flowchart illustrating another method of providing a tournament platform in a network.

FIG. 21 is a diagram illustrating an example of a crowd-funding prompt.

FIG. 22 is a diagram illustrating an example of a sponsor marketing-objectives selection and ranking page.

FIG. 23A is a diagram illustrating a first section of a portal for a social battle among selective participants.

FIG. 23B is a diagram illustrating a second section of a portal for a social battle among selective participants.

FIG. 24 is a diagram illustrating an example of content provider metrics.

FIG. 25 is a diagram illustrating an example of a battle stage.

FIG. 26 is a diagram illustrating a voting requirement element.

FIG. 27 is a diagram illustrating a wager element.

FIG. 28 is a diagram illustrating tiered voting pre-requisites.

FIG. 29A is a diagram of a separator element.

FIG. 29B is a diagram of a separator element in another position.

FIG. 29C is a diagram of a separator element in yet another position.

### DETAILED DESCRIPTION OF THE INVENTION

A description of example embodiments of the invention follows.

In some embodiments, a tournament platform is provided in which content creators and, optionally, sponsors are able to participate in tournament-style video contests. A contest can include user-generated videos, including live video feeds, augmented-reality and/or virtual-reality videos, that are submitted in response to a call for a themed tournament. The themed tournaments can be sponsored, for example, by a company or other entity that wishes to promote a brand, product, charity, political party, social message, or the like. For example, the sponsor can define the criteria for a themed contest, such as the promotion of a newly released sneaker style, which is published on the tournament platform. Users wishing to participate in the contest produce and submit videos that relate to the sponsor's new sneaker style.

To entice participation, contests often involve rewarding the winner, or a winning subset of the participants, with a prize. However, tournament structures in which an entrant provides something of tangible value in exchange for the chance of receiving a prize have the potential to be construed as a lottery, which may constitute illegal gambling in some jurisdictions. A lottery is often regarded as including three elements: consideration, chance, and a prize. In particular, a participant provides something of value (e.g., money, goods, or services) in consideration for the chance of receiving a prize. In some video tournaments, the time, skill, and effort on the part of those users who produce and submit videos may be construed as consideration. If this consideration is provided in exchange for the chance of winning the tournament prize, a tournament operator may be concerned that the tournament is structured as a lottery.

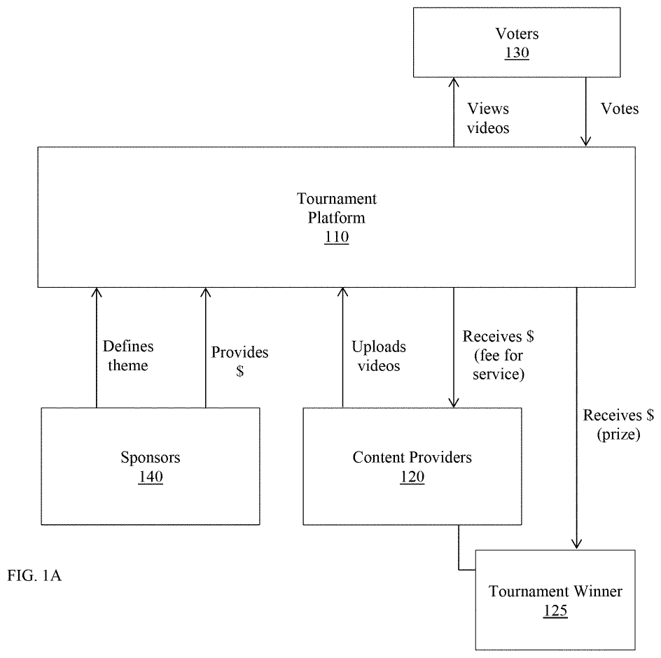

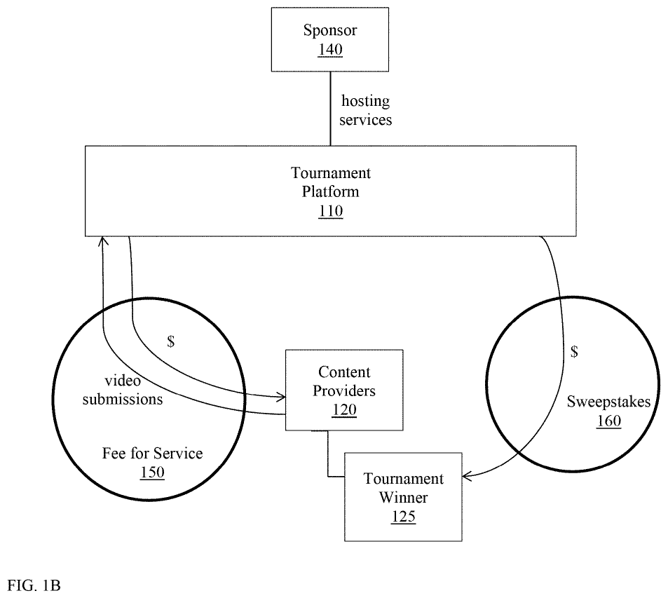

Accordingly, aspects of the present invention relate to methods and systems for providing a tournament platform include compensation mechanisms to prevent a tournament from falling under the penumbra of a lottery. For example, as shown with regard to FIG. 1A, a tournament platform 110 interfaces with users, including content providers 120, voters 130, and, optionally, sponsor(s) 140. Content providers upload videos to the tournament platform and, in exchange, receive a fee for their services. Alternatively, the contest can include other types of media, such as photographs, written works, musical works, either in addition or in place of videos. Voters 130 view the submitted videos on the tournament platform and provide votes for the tournament. The tournament winner(s) 125 receive a prize. Sponsors 140, if participating, can define a theme for a tournament through the tournament platform and provide money or other types of goods/funds for the prizes. The compensation and/or prizes provided to the content providers can be in the form of legal tender or, alternatively, can take the form of an on-platform-electronic-currency that cannot be purchased by legal tender but, rather, is accumulated through experiential usage of the platform and may, optionally, be ultimately transferred into legal tender through a digital-money-transfer-service (e.g., PayPal® services).

Sponsors, content-creators, and voters can all be considered to be users of the platform. In some instances, a sponsor may also be a content provider and/or a voter. For example, a user who typically participates by voting may, in some instances, activate a competition thereby serving as a sponsor for a tournament. Alternatively, a provider of the tournament platform may also be a user of the platform that activates a competition and/or votes on submitted videos.

In other aspects, the present invention relates to methods that do not require charging a participation fee from content providers, while still ensuring the integrity of the submitted video content, as will be described further below. With an on-platform electronic-currency that cannot be purchased and, preferably, is acquired through experiential success or history on platform, a participation fee from interested participants can, optionally, be required. The on-platform currency can also provide for optional wagers from participants that do not invoke gaming or gambling laws since the on-platform-electronic-currency can only be gained through experiential success or participation.

Generally, there are three scenarios in which an individual can win a prize: a lottery, a contest, and a sweepstakes. A lottery, as noted above, involves both consideration and chance. As typically understood with regard to, for example, state-run lottery systems, an individual will pay, for example, $1 (i.e., consideration) for a ticket having a series of numbers. If the numbers on the individual's ticket are drawn (i.e., by chance), the individual has won the lottery and receives a cash prize. In contrast with a lottery, contests typically involve a competition in which participants must do or provide something of skill. The winner of a contest is one that has been deemed to have done or provided the “best” thing, based on their skill, over the other participants. Thus, contests involve consideration (e.g., the submission of a contest entry or performance), but not chance, as the winner of a contest will not have won by chance, but rather by skill. Lastly, sweepstakes involve chance, but not consideration. Participants to a sweepstakes are not required to do or provide anything of value in order to enter the sweepstakes, and a winner of a sweepstakes receives a prize. In many jurisdictions, sweepstakes and contests are legal, while lotteries are not.

Tournaments involving video submissions may be viewed as either a contest or a lottery depending on how they are structured (e.g., physically implemented in systems hardware) and on the applicable jurisdiction's interpretation of laws. In some areas, due to the element of skill in producing a video submission, tournaments can be viewed as a contest. However, in other areas, tournament voting can be viewed as including an element of chance rather than, simply, skill. The element of chance may be seen to arise, for example, because a particularly popular voter may participate in a tournament and share a link to a video with his or her social network, prompting more votes for the video. If the video wins, it may have been, at least in part, by the fortuitous circumstances of a particularly popular voter having seen the video (i.e., chance).

As such, a tournament in which prizes are awarded may fall under the definition of lottery and can, therefore, be considered illegal gambling in some areas. In the United States, the definition of a lottery is complicated by state gaming regulations and the creation of state-by-state interpretations of what constitutes a lottery. In addition, different rules can apply to state-run versus private lotteries. Internationally, a lottery may be defined differently from country to country. For example, in the Philippines a lottery is typically defined as a scheme for the distribution of prizes by chance among persons who have paid, or agreed to pay a valuable consideration for the chance to obtain a prize. This definition varies from the definition of a lottery in other Southeast Asian countries. Because there is no consistent definition of a lottery, the availability of tournament-style video competitions as a marketing vehicle for brands is often limited. This is particularly a problem for internet-based video tournaments as tournament platforms may be hosted from any number of locations and reach voting audiences across international or state lines.

In some embodiments, tournament platforms of the present invention include a compensation mechanism to prevent a lottery-style structure. Returning to FIG. 1A, content providers 120 can receive compensation for their submissions to the tournament platform 110. The tournament winner 125, having already been compensated for his or her submission, receives a prize outright. The content providers 120 are not be charged an “entry fee” of tangible value to join the tournament. However, the content providers 120 can, optionally and through on-platform currency, be charged an entry fee to join a contest, with the on-platform currency being a digital representation of, for example, an accumulated number of points, on-platform currency or dollars, or awards generated through experiential success on the platform and not through the deposit of legal tender into the providers' accounts

FIG. 1B further illustrates an embodiment of a compensation mechanism. A sponsor 140, wishing to engage content providers 120 in a competition without running afoul of local lottery regulations or engaging in a burdensome regulatory review process, hosts a competition on tournament platform 110. The content providers 120 of the video submissions can be compensated for their efforts, amounting to a fee for service 150 arrangement. Upon completion of the tournament, a tournament winner 125 is awarded with a prize, amounting to a sweepstakes 160.

Tournament platforms of the present invention provide several advantages for both content creators and sponsors in addition to obviating the creation of a lottery. For example, a sponsor may be a company that wishes to generate buzz around a brand or a new product offering. Rather than directly creating or commissioning advertising content itself, as well as placing and managing this content on various ad websites, the sponsor is able to connect with content providers through the tournament platform who can produce video submissions that relate to the brand or product. The sponsor is also able to reach the viewing public through the tournament platform. As tournaments are hosted, voters view the sponsored content and are actively engaged in selecting and promoting quality content.

Meanwhile, by participating in themed contests, content creators are able to produce video that is of value to a sponsor and are able to receive compensation for their work. Content-creators also receive public recognition for their work as their creations are broadcast to the public. Popular tournaments may garner larger audiences as participants (e.g., sponsors, content-creators, and voters) are encouraged to pass on the video submissions to others. As the video submissions receive an increasing amount of attention, public awareness of the sponsor product or brand grows and the content provider receives an increasing amount of recognition for his or her work. Tournament platforms of the present invention can thus provide a tool for viral-campaigning in a networked environment.

As tournaments can be structured such that a basis of a tangible entry fee to participate is not required, an opportunity is created for content-creators to participate in winning large prizes without the legal-tender cost associated with a lottery. Sponsors of tournaments are interested in the viral-marketing through a crowd-marketing impact that comes with participants' looking to move forward successfully in the contest. Additionally, because of the creation of on-platform-currency that can be awarded through experiential success, the platform provides for options in which users may “wager” versus one another with stakes of value that do not constitute illegal gambling as no stakes of tangible value are being exchanged.

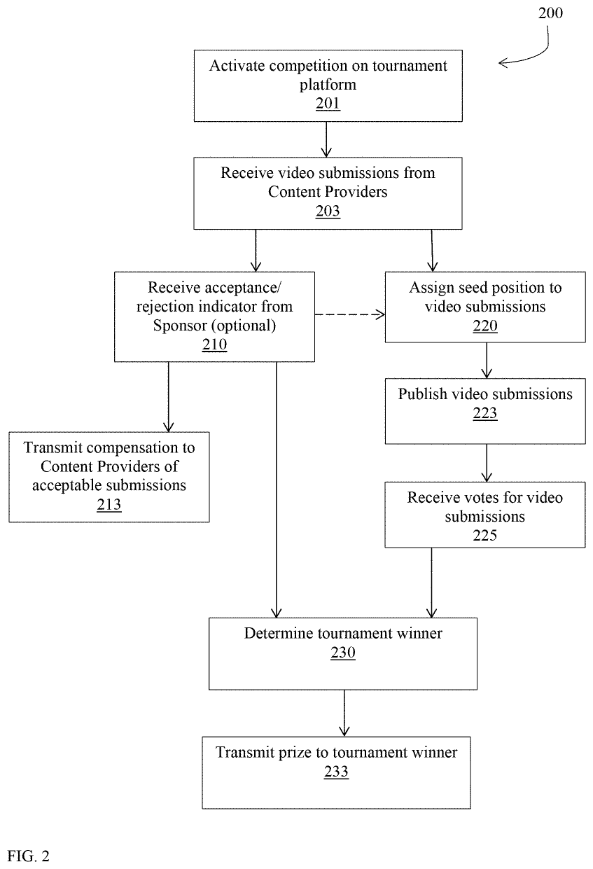

An example of a method for providing a tournament platform in a network is illustrated in FIG. 2. The method 200 initially includes activating a competition on the platform (step 201). The activation of a competition can include publishing a basis for the competition and criteria for acceptance of video submissions for the competition. The basis for a competition and the acceptance criteria can optionally be defined by a sponsor. Once published, video submissions are received from content providers (step 203). Video submissions can undergo an optional review process (step 210) prior to compensation being transmitted to the content providers of acceptable video submissions (step 213). The optional review process (step 210) can include varying stages of review, including, for example, sponsor review, platform review, or both. During sponsor review, a scoring of each video can be performed based on the mechanics established by the sponsor. There may be multiple sponsors assigned to each contest and each sponsor or an average of sponsor review ratings can form the basis of video approval. If both sponsor review and platform review are to occur, the reviews can be performed sequentially (e.g., first sponsor review, then platform review, or vice versa) or in parallel. The platform review can include additional screening or rating factors, such as facial-recognition scanning. Additionally, during platform review, a scoring of each video can be performed based on mechanics established by the sponsor, by the platform, or both. Furthermore, the score provided by the platform can be used to justify the acceptance-cost of each video entry for brand sponsor into their contest. In this way, the analysis of a video can help to determine the value of its entry into the contest for a sponsor. One or more metrics can be used to determine the impact of each video entry, including previous success with content on platform, global standing as a content creator on a platform leaderboard, production quality and skill of the content, relevancy of the content to the brand's marketing campaign and needs, historical traffic and viral-traction of a content creator, and the like. Beyond just a score, a per-piece price can be attributed to each specific piece of content for which sponsor can be charged upon approval of entry into their tournament.

Either the sponsor or the tournament platform may reject the content. For example, content may be automatically rejected if the content does not pass a facial-recognition approval from the account creator. Upon approval by all parties, compensation may be transmitted (step 213). Alternatively, a tournament can option to turn off scoring by the platform and/or sponsor, allowing submitted content to immediately qualify for a tournament.

The tournament can assume the form of a series of contests between the video submissions, with each video submission being assigned scores by tournament-platform review and/or sponsor-review that determine an initial seed-position (step 220). The seeded video submissions are published (step 223) and votes are received (step 225) from an internet audience. The voting of the video audience, in conjunction with the optional scores by tournament platform and/or sponsor(s) determine the success of an entry versus its competition in-contest. If an acceptance/rejection indicator from a sponsor is required, the sponsor review process (step 210) can occur either sequentially or in parallel with the seeding and publication of the tournament video submissions (steps 220, 223). For example, a tournament platform can include a sponsor interface, whereupon a sponsor may perform a review to determine whether or not each video submission is aligned with the basis for the competition (e.g., theme) and/or meets the published criteria (e.g., inclusion of a particular product, content provider eligibility, video duration, etc.) and, if so, compensation may be provided. A winning content provider is determined based, at least in part, on the received votes (step 230) and an award or prize is transmitted to the winner (step 233).

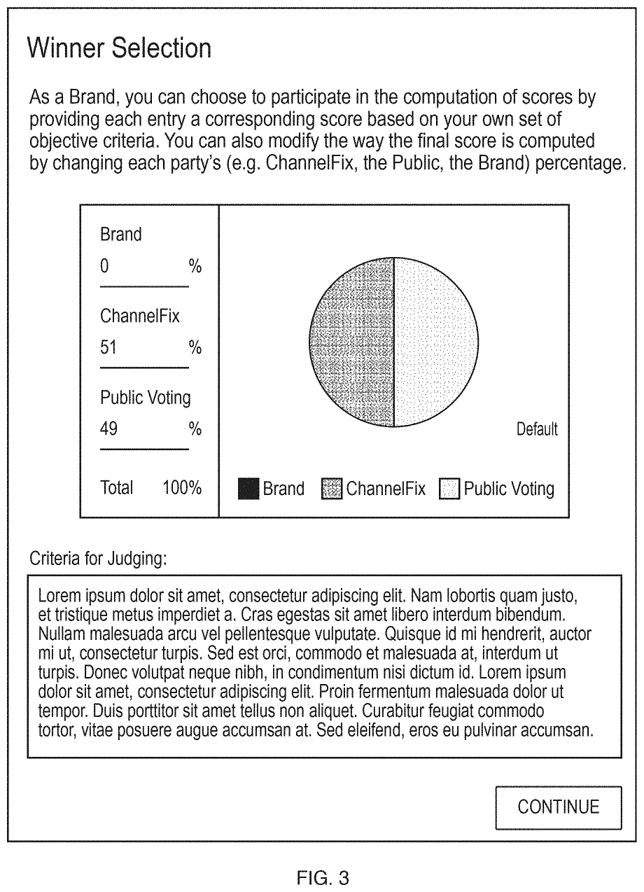

A tournament competition can be structured such that scoring includes a sponsor-review component, multiple sponsor-review components, a provider-review component, an audience public voting review, or any combination thereof. An example of a tournament weighting structure is shown in FIG. 3. The tournament platform provider and/or a sponsor can determine a customized weighting structure for each contest, with the weighting structure applying to each video submission for that contest. As illustrated in FIG. 3, a final score for a video can include a provider-review component accounting for 51% of the overall score, while public voting is set to account for 49% of the overall score. A number of configurations are possible. For a further example, a weighting structure can include a provider-review component of 31% for production value, a sponsor-review component of 20% for relevancy to the theme, and 49% for public voting. The sponsor- and/or provider-review scores for particular video submissions can optionally be published to the internet audience. Additional weight categories are also possible. For example, public voting may be tiered, with voters organized into various categories (e.g., elite voters, anonymous voters, professional voters, brand-employee voters, etc.) and each category being provided with a different weight. Public voters can have different voting power and voting capacity based on their completion of experiential requirements within the platform. Additionally, voting can be restricted to those users with an exclusive invitation to vote.

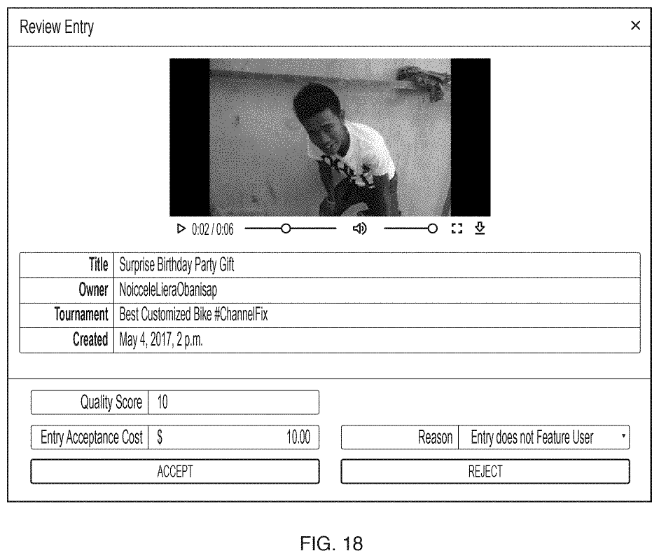

The compensation amount provided as a fee-for-service to each of the video submission entrants can be published upon activation of the competition on the tournament platform as an optional, additional incentive for users to submit content. The compensation amount can be published as a standard acceptance bonus, an individual compensation amount based on a user's specific entry, and/or, as a total amount provided by the sponsor. For example, a sponsor can provide a set fee of $10 per acceptable video submission and set a cap of 1000 submissions. Upon receipt of the capped 1000 submissions, the tournament platform can be configured to close video submissions for the contest. Additionally, each user may upload a compensation amount that they want in order for their content to be accepted and allowed into the contest. For example, a user can have a requested set compensation amount for all video entries. Alternatively, a user can provide a compensation amount when submitting a specific piece of content, and a content sponsor can then review and accept or reject the user's submission based, at least in part, on the user's requested compensation amount. For example, a content sponsor can select from accepting a submitted video for a requested compensation amount, reject the video, or negotiate the cost by proposing a different compensation amount, which is then messaged to the user. The user, upon notification, may then accept or reject the newly proposed compensation amount. Alternatively, or in addition, a compensation amount, or adjustment of a compensation amount, can be provided at a quality-review stage by the tournament platform. For example, upon review, an acceptance price can be assigned to a video in addition to a quality review score. The video content, together with its acceptance price, can then be routed in workflow to the sponsor for sponsor review and acceptance. An example of sponsor review prompt is shown in FIG. 18, with, for example, a specified acceptance cost of $10 and fields for the sponsor to provide a quality score and prompts to accept or reject the entry.

The platform may place an additional amount on top of the user's requested or assigned compensation. Furthermore, during review of entries by the platform, the platform can decide to determine an acceptance price for each specific piece of content with a determined amount going to the content-creator as compensation. In this way, the sponsor chooses if each piece of content is worthy of admittance into their contest and bears the costs of each piece of content, both to the platform (e.g., fee-for-service) as well as to the content-creator (e.g., compensation). Alternatively, a sponsor can provide a set amount, for example, $10,000, for all acceptable video submissions received through a certain date/time, with the $10,000 being divided among the content-creators based upon the number of acceptable entries received. The set fee paid by the sponsor can also be a charge-per-user. The fee for accepted entries can be consistent for all approved entries or it can be variable, such as by being based on the experiential success of users on the platform. For example, a user with a significant amount of experience, followers, previous success, total number of votes, total number of uploads, total number of contests won, recent success defined in a period of time, previous success defined in a period of time, or any combination thereof can command a premium rate for acceptance into a contest.

The tournament platform can further be configured to charge sponsors to initiate a contest, to charge sponsors per approved video content submission, to charge content providers for entries submitted to the contest, to charge sponsors for the success of the contest through quantifiable metrics (e.g., number of views, votes, clicks, submission of entries, or any combination thereof), and/or to charge for the successful completion of a contest. Sponsors can also be charged for any supporting advertisements on the pages of the contest.

While each contest may be fully open to the public, with both video submissions and votes originating from a general population of internet users, other configurations are possible. For example, the submission of video for a particular tournament can be limited to content providers that have registered with the tournament platform or, in the case of an exclusive or private tournament, that have been invited to participate or otherwise have been granted access, such as by a specific URL. Similarly, voters may be limited to users registered with the tournament platform, or have been invited to otherwise granted access to vote in exclusive tournaments.

Content providers and voters can also be categorized based on metrics. For example, content providers can be organized based on provider metrics, such as, for example, a number of submitted videos, number of winning videos, percentage of submitted videos having won a competition, percentage of winning videos across several competitions originating from the provider, number of competitions entered, average votes per submitted video, or any combination thereof. Additionally, some contests may require the acceptance-fee of on-platform-currency that can only be gained through experiential success on platform. Additionally, some contests may be exclusive to users who have achieved experiential-success on platform over a certain period of time, or exclusive to users who achieve experiential-success through specific contests. In addition, some contests may be closed to users who have not performed enough experiential requirements on platform, making them ineligible to join. Additionally, the prize for winning a specific contest can be qualification or acceptance into exclusive contests or tournaments, or continuation of eligibility into next-level contests.

The tournament platform can further provide for publishing and/or vetting video submissions based on prerequisite requirements. For example, a sponsor and/or the tournament platform provider may want to encourage high-quality submissions above a level typically received from a competition open to the general population of internet users. The tournament platform can be configured to present a content-provider listing to a sponsor, with participation invitations transmitted to sponsor-selected content providers. Thus, a sponsor invitation can be a prerequisite for submitting a video in exchange for compensation in relation to a particular contest. In addition, or alternatively, other prerequisite requirements can be imposed, such as, for example, a provider metric, proof of purchase of an item, proof of existing ownership of an item, proof of attendance at a virtual or physical event, identity confirmation, entry of invitation code, invitation by the platform, contest-creator, or sponsor, or any combination thereof. Acceptance of a license agreement may also be a prerequisite requirement. For example, a license agreement may be published, and upon submission of a video, a content provider may be required to enter into the license agreement with a sponsor, the platform provider, or both, to provide a license for future use of the video. Ability to pay an entrance fee of on-platform-currency gained through experiential success may be a prerequisite requirement.

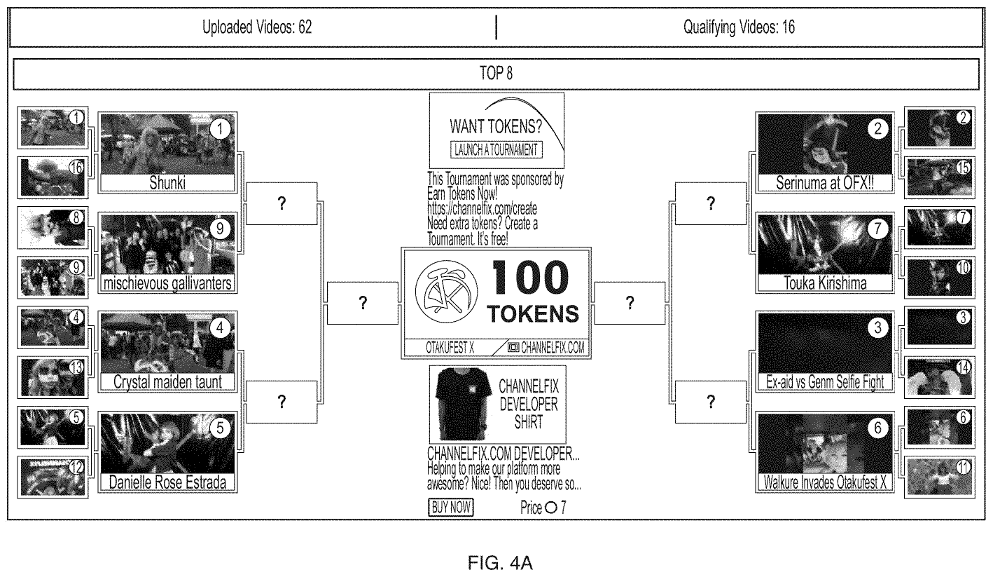

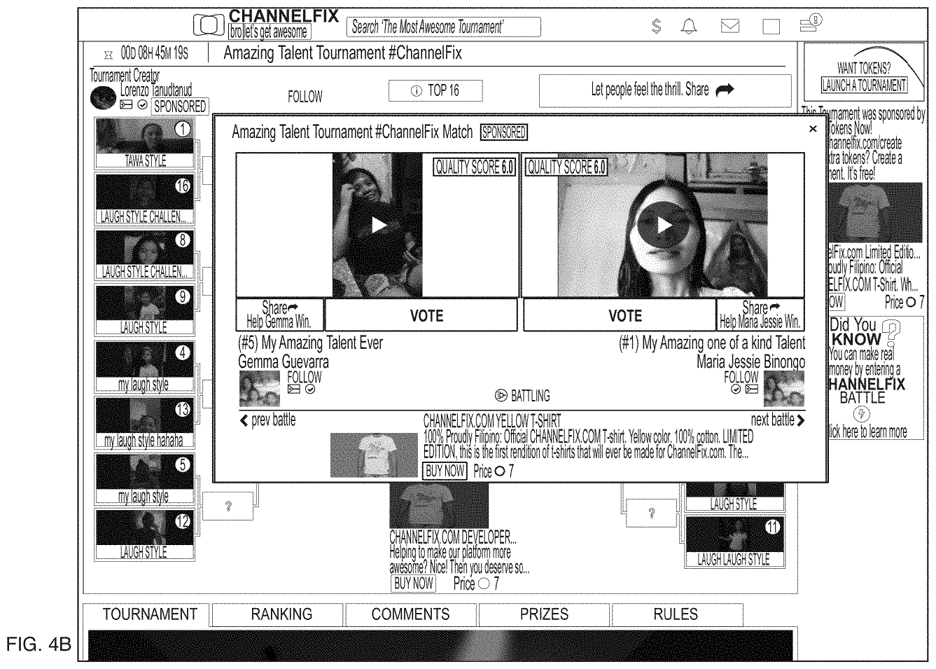

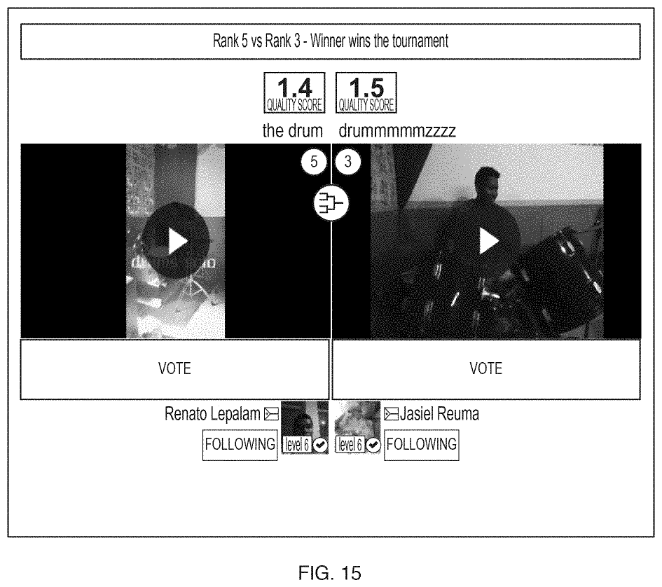

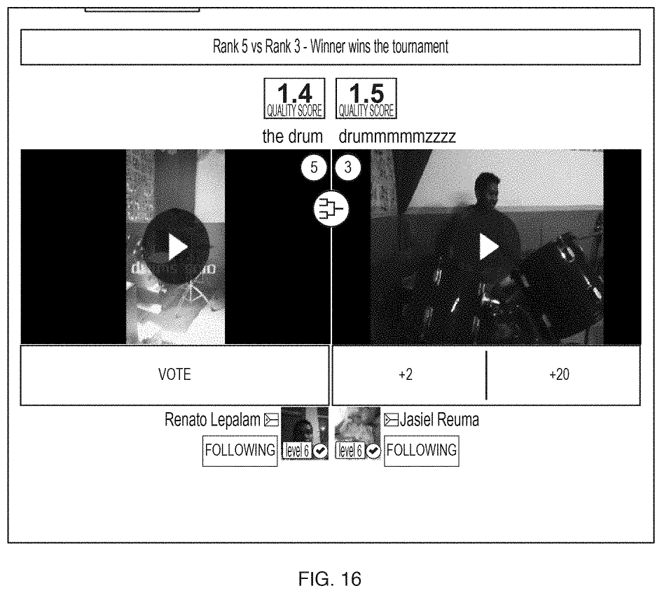

Prerequisites can also be required for voters. For example, voting for a tournament, or for particular rounds of the tournament, can be by invitation only. Prerequisite requirements for voters can include, for example, a voter metric, proof of purchase of an item, proof of existing ownership of an item, proof of attendance at a virtual or physical event, identity confirmation, entry of invitation code, visiting a brand's website or destination URL, downloading an app, acceptance of video-content-entry into the contest, or any combination thereof. Prerequisite requirements for voters can also be the purchase of votes. Voters can, optionally, have varying amounts of voting power. For example, an expert panel of judges may comprise voters with significant voting and/or content-providing experience who have increased voting power over the general internet audience. In addition, or alternatively, voters may be presented with an option to purchase increased voting power. For example, when presented with videos in a head-to-head elimination round (FIG. 4B, FIG. 15) additional options may be provided to purchase a “super” vote (FIG. 16).

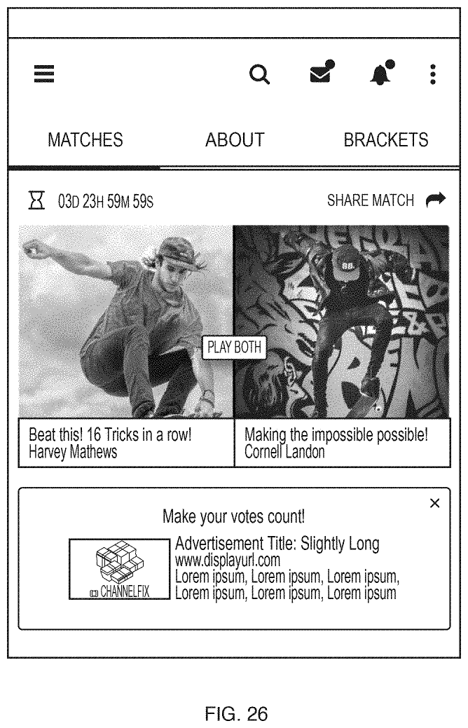

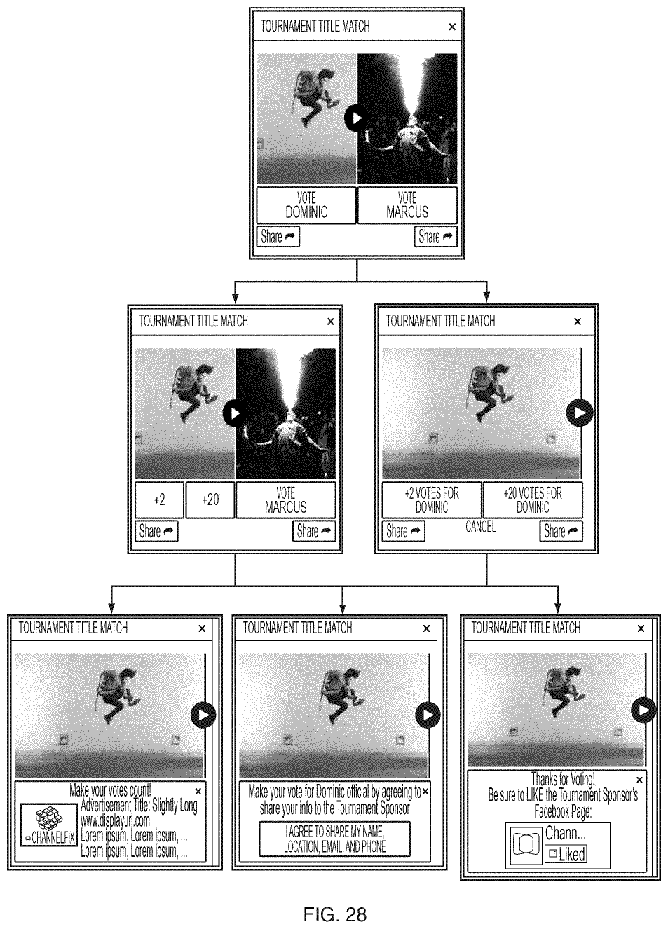

Prerequisites for a voter to proceed with a vote can also be required. For example, a pre- or post-vote action by the voter may be required by the tournament platform, the sponsor, or both in order for the voter to proceed with his or her vote, or to have his or her vote counted. As shown in FIGS. 26 and 28, the pre- or post-vote activity can be an HTML embedded element at or near the voting buttons, or placed over the voting buttons. Such pre- and post-vote requirements can help to create a more accurate user profile of the voter, ensure voter integrity, and/or accomplish marketing objectives of a sponsor, as will be described further below. For example, options for pre- or post-vote requirements include presenting the user with a requirement to click to be redirected to another page on the platform or to another website, a requirement to provide user-verification information, such as a phone number, a requirement to click a sponsor-chosen URL, such as a Facebook page to LIKE the page, a requirement to opt-in to sharing personal data with a sponsor, an introduction to an e-commerce purchase opportunity, opting to follow the sponsor on the platform, a requirement to watch a sponsor-chosen advertisement and answer questions about the advertisement to assess user-reaction, a requirement to install an app, such as a sponsor app available at GooglePlay® or the Apple® store, a requirement to download a song from the platform or from other music networks, a requirement to confirm user information, such as user gender, physical location, interests, and date of birth, and/or a requirement for the user to upload a video of themselves for user verification.

In some embodiments, accepted video submissions are assigned seed positions to form a single-elimination-style tournament (e.g., top 2, 4, 8, 16, 32, 64, etc.). For example, 350 received video submissions may be approved for a contest. The 350 video submissions may be optionally assigned scores by platform- and/or sponsor-review. In this example, these videos will compete for 16 Top positions. These 350 videos can then compete for “seed” position, wherein the top 16 approved submissions (or, the top 32, 64, 128, etc. by way of iterations of single-elimination-battles) that received the highest store(s) based on review are seeded into positions 1-16. The 350 videos thereby jockey for position based on scores by the platform and/or sponsor-review, as well as public voting. In some configurations, the platform can automatically assign the top 16 videos, if necessary. The 16 video submissions then participate in a series of head-to-head single elimination rounds, as shown, for example, in FIG. 4A. Advancement to the next round occurs for the video receiving the highest score (e.g., based on a computation of public voting, and optionally, provider-review and/or sponsor-review). The process continues until one winner is declared. An example of a head-to-head elimination round is shown in FIG. 4B, with a voter being presented with the entries of two content providers and voting buttons with which to select his or her preference.

A tournament can be structured to provide a compensation amount as a fee-for-service to all submitted video submissions or, preferably, to content providers having submitted an acceptable video. For example, of the 350 received submissions, 30 videos may meet all acceptability criteria and/or prerequisite requirements. The content providers of the 30 acceptable videos can receive a fee-for service. All 30 videos can participate in a tournament; however, due to the structure of a single-elimination style tournament, 30 may not be a convenient number for a particular tournament. As such, rather than 30 videos being seeded into an uneven competition, the best 16 videos of the 30 may be seeded through a determination by platform, by sponsor, by public-voting, or by any combination thereof. The “best” 16 videos can be those that, for example, received the highest score in a sponsor review for theme-relevance. As a further alternative, the content providers of the 16 best videos may receive a higher compensation amount than the remaining of the 30 acceptable videos.

A tournament can have an optional stage, or multiple stages, where a number of approved entries not suitable for single-elimination-style tournament can jockey for position into an actual single-elimination-style-tournament. In this stage of such a tournament, a number of approved entries not suitable for single-elimination-style tournament (e.g., 30 entries) may be settled down into a number suitable for single elimination style tournament (e.g., 16, 8, 4, or 2, etc.) There can be multiple stages of this kind (e.g., two stages of this kind could provide for 30 entries down to 25 entries, and then 25 entries down to 16 entries.) In this stage, all approved entries can be put into a visible list, in which they can originally be listed randomly, or by platform review, by sponsor review, by experiential standing or success on platform, or any combination thereof. In this way, the number of videos can be sorted either randomly or through a quantifiable ranking. Furthermore the order of this list can be impacted by popular-voting so that the initial order of the list can change through a set time period of public-voting. At the conclusion of this stage, the top entries needed to make a suitable single elimination style tournament (16, 8, 4, 2, etc.) will advance to an actual single-elimination-battle. In addition, a winner can be determined based on such popular voting stage(s), where the user/video that finishes first among any number of approved entries is declared the winner.

The compensation amount can be in the form of currency, remittance for goods, remittance for services, physical items of value, other items of value, such as an invitation into exclusive contest(s) or publicity, or any combination thereof. Similarly, an award to the winner of the tournament can be in the form of an amount of currency, remittance for goods, remittance for services, physical items of value, other items of value, or any combination thereof. Currency can include cash, electronic coins or tokens, Bitcoin, crypto-currency, on-platform currency, or coupons having cash value.

The tournament platform can also include a sponsor interface. The sponsor may input or upload information relating to the product or service that the sponsor wishes to promote directly to the audience that participates in the contest. The sponsor can also provide a distinct video or advertisement to be presented to contest participants, whereby the participants can directly purchase items introduced to them at the conclusion of the contest from direct-messaging through the platform, SMS/text, emails, or increased advertisements introducing the product. In addition, a sponsor may arrange to ship a sample product to all content providers, content providers of acceptable video submissions, voters, or any combination thereof. Alternatively, or in addition, the product can be provided as promotional material to users.

Additionally, sponsors can coordinate requirements to enter their contest, such on receipt of a sample product and/or use of the sample product in the video submissions may be a prerequisite for a competition. Additionally, the sponsor may include a “skin,” image, downloadable music, image, video, or “layer” requirement wherein all video uploads will need to have this downloadable-element in their video entry to qualify for acceptance into the contest.

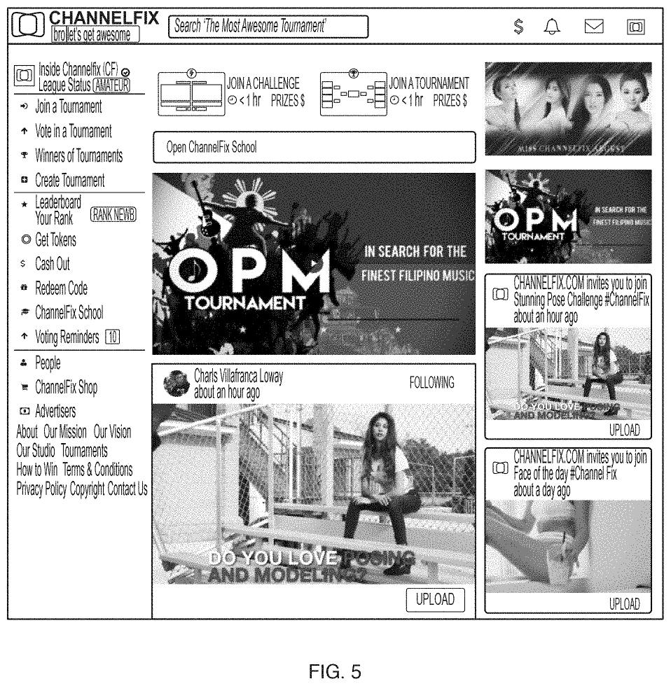

The tournament platform can also include a user interface for voters and/or content providers, as illustrated in FIG. 5. The interface can include links to activate competitions, with themes, prizes, remaining duration for submission, remaining duration for voting, and the like visible to users.

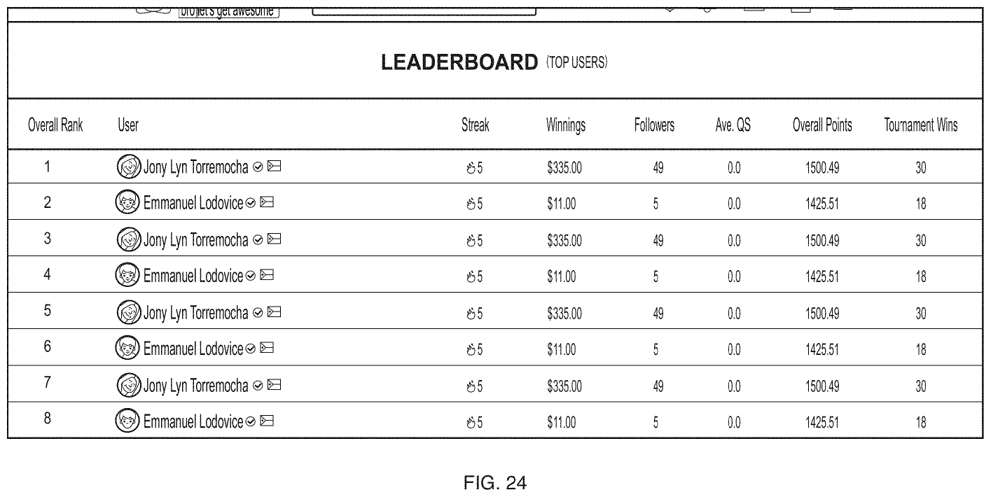

The tournament platform can thus serve as a portal where content providers can freelance work for sponsors' video campaigns. Further, content providers can gain recognition through league structures and leaderboards. An example of a Leaderboard is shown in FIG. 24. For example, a leaderboard can highlight content creators with the most wins, most videos, most videos in a category or theme, and the like. Content provider metrics and recognition can further allow sponsors to match the mechanics of a tournament with their marketing purpose, either by setting prerequisite, content provider criteria at the start of a tournament, or by allowing the public to select to the best content providers out of a large cohort. The Leaderboard can be determined by overall history, seasonal-history, geographic location, and/or age. Additionally, the results of this Leaderboard can qualify users for acceptance into exclusive invitational-contests.

For example, assume that a couture clothing company wants to find a new face for its next modeling campaign. Thousands of videos are submitted from content providers each wanting to be the next model. Of the thousands of videos, 500 videos are approved by the sponsor or tournament provider as being acceptable, and the content providers of the 500 acceptable videos receive a fee in exchange for their service. The 500 videos proceed in a tournament, with, eventually, all 500 videos settling down into the top 8 videos (e.g., based at least in part, by platform review, brand sponsor review, and/or public voting). These 8 videos are then seeded into the final single-elimination style contest based on the order of the top 8 videos (e.g., seed #1 versus seed #8, seed #2 versus seed #7, etc.). The clothing company can then invite the content creators of the top 8 videos to their corporate-headquarters, with the remaining elimination rounds being entirely based on company vote, or based on a combination of company and public vote. The remaining elimination rounds can be based on new or re-filmed videos. In this format, the tournament platform enables the sponsor clothing company to reduce a large number of uploads into a more manageable group of popular, public faces. The clothing company can then proceed with officially judging the final 8 models, with the public remaining engaged in the process. Additionally, the clothing company may invest significant resources in the video-creation for the final 8 models in a way that would be difficult to achieve with 500 contestants throughout the world.

In some embodiments, tournament platforms can provide standalone contests, or, alternatively, classify competitions by leagues having a shared purpose or general theme. The use of leagues, with leaderboards to highlight ranks, can give consistency and purpose to participants, generating recurring interest. Both content providers and voters can be classified based on experience. For example, newly-active participants can be seeded to perform against each other, while more experienced participants are classified into higher level leagues. By tracking the success of users and funneling these results into a structured leaderboard, sponsors may utilize the tournament platform to invite particular content providers to exclusive competitions. For example, a sponsor may wish to have videos provided only by elite or experienced content providers within a particular league. Alternatively, the sponsor may wish to invite only amateur content providers. Similar to an end-of-season ranking for sports leagues, a selected group of content providers of one or more particular leagues can qualify for a high-level event involving high cash fees and prizes, similar to end-of-season games for various sports leagues.

In addition, high ranking content providers can establish themselves as a leader in, for example, their geographical region, subject matter niche, or other category. High-ranking users can be eligible for higher fees for their services. For example, rather than a sponsor or the tournament provider publishing a set fee for a competition, high-ranking users can set the fees they are willing to accept to participate in a competition. Thus, sponsors can review whether it is worthwhile for them to close a competition to elite content providers, or invite particular providers who will command a greater fee than others participating in the same contest.

For example, a sponsor can be presented with information regarding a particular user, such as a content provider or a voter. Information such as a user's location, number of followers, number of entries, experiential-success indicators from the platform, and number of prizes can be presented, along with a variable cost to invite (e.g., $5 U.S. Dollars), based on experiential elements, user's location, and/or review of content by platform. Sponsors can opt to select the user, thereby inviting the user to participate in a tournament. Similarly, a sponsor can request that particular voters be invited to vote on video submissions for a tournament. A user's cost can be determined based on the user's prior success in winning prizes, the user's rank (e.g., in a league, among others of similar demographics, or among all users), and previous history with the tournament platform. For example, a sponsor can be charged a premium to include content submitted by a user with 100,000 followers. As an alternative example, a sponsor can be provided with significant savings upon selecting “new” users without many followers or historical success.

A sponsor can invite users having varying compensation amounts to a tournament. Sponsors may be charged a fee that is commensurate with the variable charges of the users that the sponsor has selected to participate. For example, the charges to the sponsor can be applied as the sponsor approves submissions from the content-providers.

Leagues and leaderboards can also provide for users to challenge one another on the tournament platform to one-on-one tournaments, or within larger brackets of tournaments, with a centralized theme or concept. Such private battles may impact the results of a leaderboard standing, as opposed to resulting in any direct cash or goods prizes.

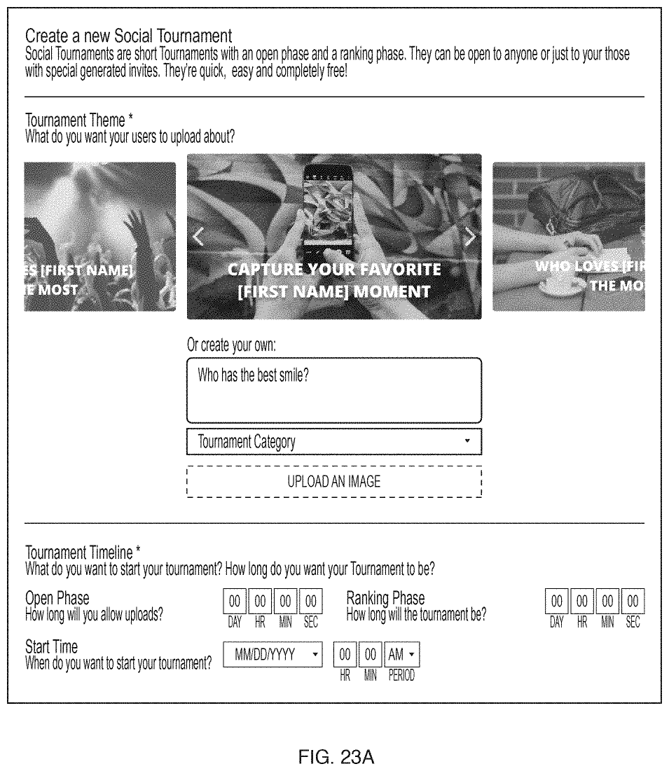

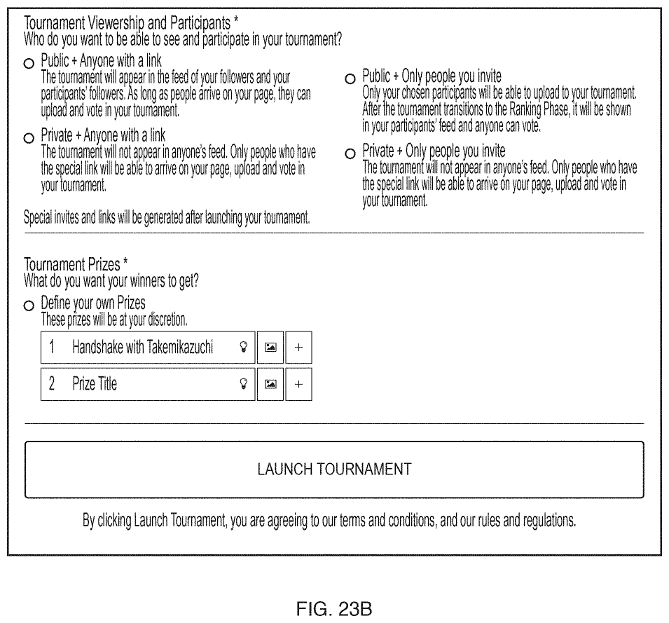

Tournament platforms can also provide for social contests among friends with platform-generated prizes, friend-chosen prizes, social prizes, or publicity prizes. In such social contests, accessibility to submit videos, to vote, and/or to view the contest is limited to invited users or to those users gaining access to the contest through a specific URL. Such contests can be public, allowing other users to see the contest, even if they cannot upload videos or vote in the contest, or fully private. In this way, a group of friends can have an intimate social contest, with one of the friends functioning as the sponsor to create a contest through a portal, as shown in FIGS. 23A-B. A sponsor in this portal can choose from an existing generic theme or custom create a description to function as the theme. The sponsor is given editing tools to configure the duration of the contest, as well as who will be allowed to enter, join, vote, and/or see the contest. Finally, the sponsor can choose from platform-generated prizes, or can create or provide their own prize.

### Tournament Stages

A method of conducting a tournament can include several stages of events, such as an activation stage, a video receipt stage, an acceptance/compensation stage, a ranking stage, and a battle stage. Each stage is discussed in turn, and each stage can be included or omitted from a tournament in a modular fashion.

In an activation stage, the tournament provider and/or the sponsor can publish a basis for competition and criteria for acceptance of video submissions for the competition. Optionally, the basis for the competition can be selected from an existing list of tournament concepts and/or themes. The existing list of tournament themes can include past competitions, standard competitions, or both. A sponsor can select from the list and rebrand the standard or template information to suit their needs. For example, a sponsor can be presented with a page containing a template title, description, and image or video. The sponsor is able to edit any of these fields to customize a competition from the template. Such an option allows a sponsor without video-editing abilities or a sponsor wishing to quickly set up a competition to do so without having to independently create, for example, a “call to action” video. Alternatively, a sponsor can input a basis for a competition from a blank template and upload its own “call to action” video. A sponsor may just provide a “call to action” image in the event that they do not possess video editing capability, or a “call to action” written description in the event they possess neither video nor image editing capability. A “call to action” video, image, and/or written description can present information regarding the tournament to users of the platform. The call to action video can include, for example, images or video pertaining to the theme or product, information regarding the acceptance criteria, any compensation and prizes associated with the competition, any post-tournament offerings for participating in a competition, and the like. Alternatively, a sponsor may launch a generic contest, without editing any of the fields to customize the contest.

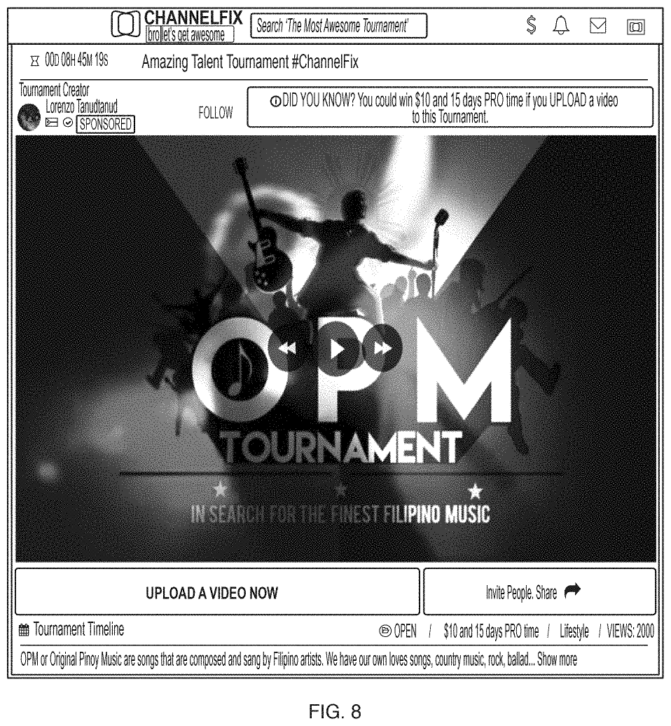

Following activation, users are able to view the call to action video and/or any other associated information. Users are then able to upload videos to the tournament platform to compete in the competition in the video receipt stage, as shown in FIG. 8. Users may be presented with a timer indicating the closing of the competition. Alternatively, user may be presented with a ticker to indicating the number of video entries received to date out of a maximum number of allowed submissions.

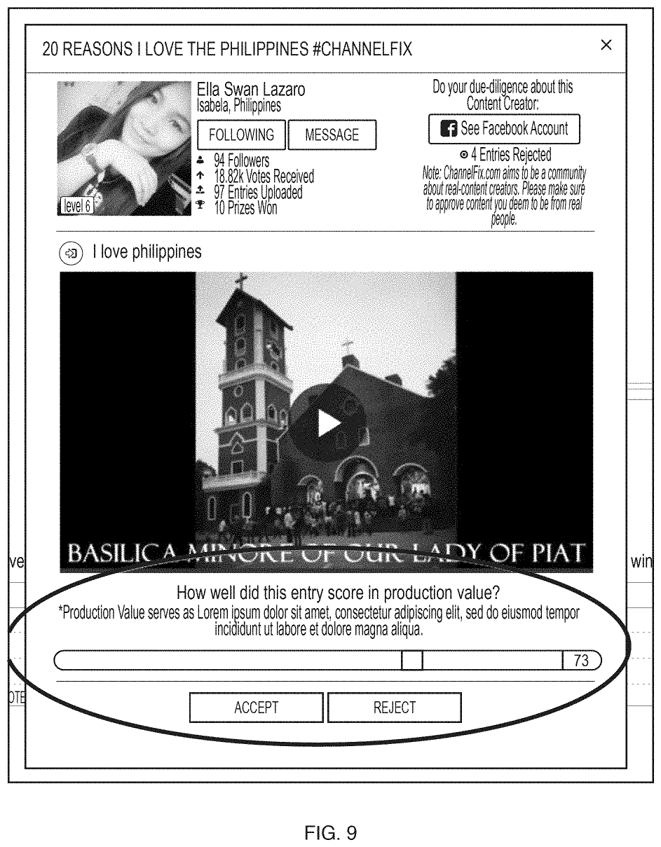

During or following the video receipt stage, a sponsor is able to optionally accept or reject specific entries into its contest. As shown in FIG. 9, a sponsor can be presented with each video entry and given the option to accept or reject it. In addition, or alternatively, the videos can undergo an acceptance/rejection process by the platform provider. Upon acceptance, a compensation amount can be transmitted to the content-provider of an accepted video. Also upon acceptance, a fee-for-service amount can be charged to the sponsor for each approved video. In addition, content-providers may receive a participation award. The participation award can be transmitted to the content provider by way of tokens, or other usable currency on the tournament platform, or goods. In some configurations, such as in private social contests, entries may alternatively be automatically approved for inclusion into the tournament and no further sponsor or platform indicator is performed.

Sponsors are also optionally able to score each entry with a Quality Review Score based on their objective criteria, contest requirements, or both as part of the acceptance/compensation stage. For example, if a weighting structure has been defined for a competition (FIG. 3), a sponsor and/or platform provider can provide a rating or a score corresponding to their review for theme relevance, production value, or the like. As shown in FIG. 9, in addition to Accept/Reject options, a Sponsor can be presented with a scoring option, illustrated as a slide-bar (highlighted by an oval), to rank the video on a scale. The scale can range from, for example, 10-100, 1-100, 1-10, 1-20, or the like.

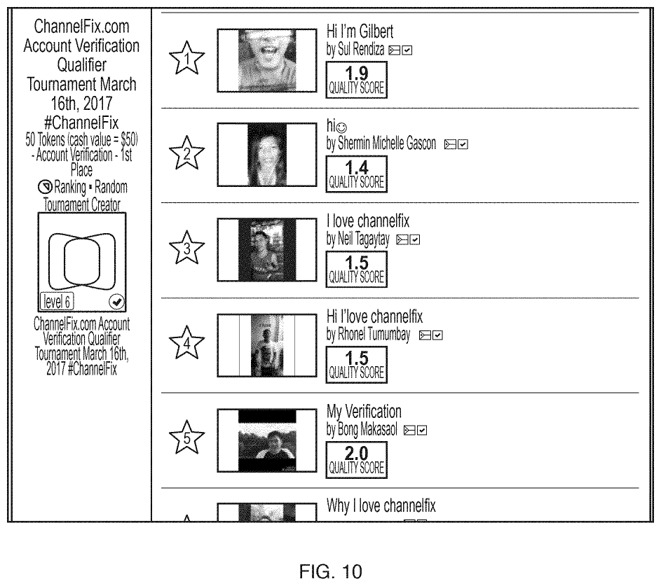

The ranking stage can occur after receipt of a number of video entries or after a period of time. Ranking of the videos can occur to determine the seeding order of the videos. The ranking can be based solely on sponsor review, provider review, public review, or any combination thereof. The ranking stage is optional. There can be one ranking stage, or there can be multiple ranking stages. During the public review, video submissions are presented to users and users may rank or vote on such submissions. For example, as shown in FIG. 10, a listing of submitted videos is presented to a user with the user having the ability to click on and vote or rank any particular video. The videos can be presented in a random order, or in an order representative of their current rank. Additional information, such as the Quality Score by the Sponsor and/or the Platform, the total number of votes, and the current or final score can also be presented. A popup indicating how the score is calculated can also be presented.

The ranking stage can be limited by a period of time, by a number of videos, by a number of videos reaching a certain threshold of votes, or any combination thereof. The final ranking of the videos can be based on a Final Score as determined by the weighted averages of each of the Quality Review Score(s) and the popular ranking votes. For example, a final score for a video in a competition having defined weights of 51% for sponsor review and 49% for public review can be determined by the following equation:

$$Final Score = ( \frac{Quality Score}{Perfect Quality Score} \cdot 0.51 ) + ( \frac{Total Entry Votes}{Total Ranking Votes} \cdot 0.49 ) . \qquad ( 1 )$$

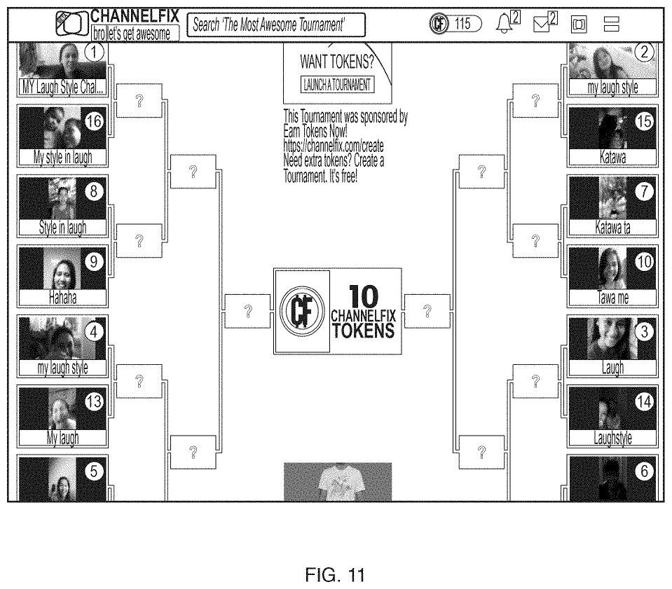

The ranking stage can also be optional. A ranking phase can be helpful in bringing increased viral attention to a contest; however, a contest may proceed directly to a battle stage and the determination of a winner. The ranking stage can assist with weeding out the lowest qualified videos of a pool of several hundred or several thousand video submissions and producing a smaller list of high-quality videos. The final scores of the ranking stage can be used to seed the videos in the battle stage. For example, during the battle stage of a tournament, the sixteen videos with the highest final scores are paired into sets of a single-elimination style tournament, as shown in FIG. 11. The initial pairing of videos can be determined based on the final scores. For example, the video with the highest final score (e.g., video no. 1) is paired against the video with the lowest final score (e.g., video no. 16).

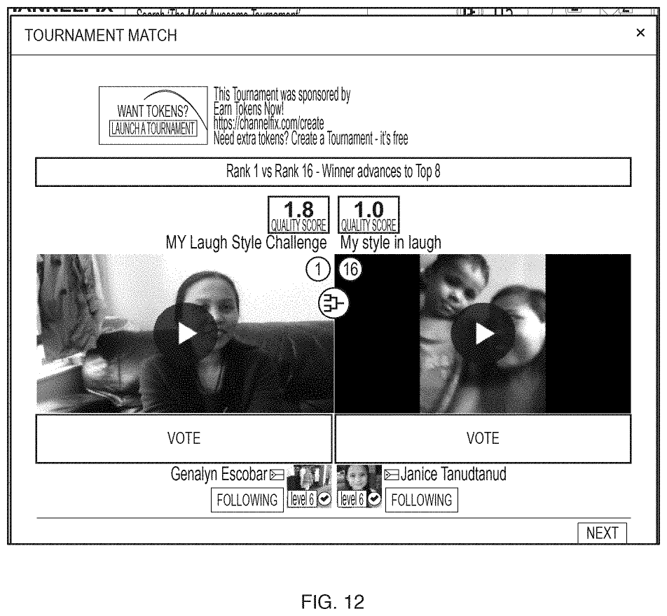

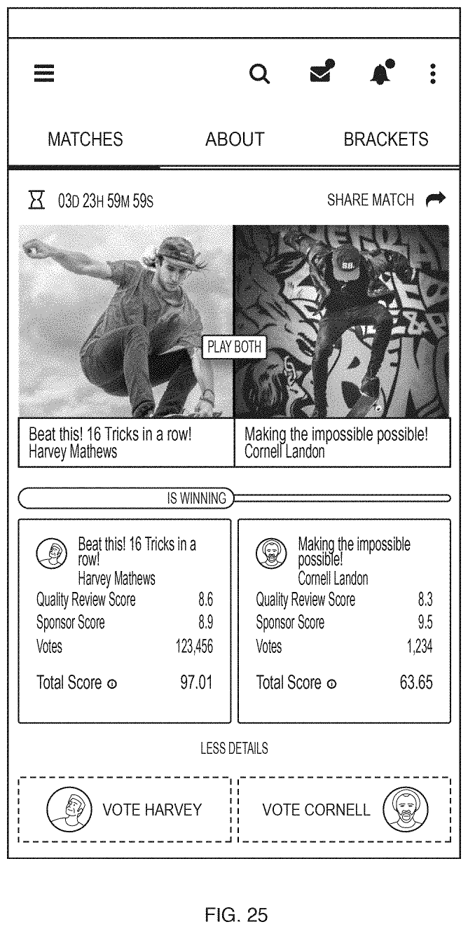

During the battle stage, voters are presented with a side-by-side view of the seeded videos, as shown in FIG. 12 and FIG. 25, with the option to vote for either video. The Quality Scores, as determined from sponsor and/or provider review, may be visible to voters. Each battle may be open for a period of time or until a threshold number of voters have viewed and voted upon the videos. The winning video of each battle progresses in the tournament, until one winner is declared.

Prizes can be provided to the winner and/or to any number of finalists. For example, the largest prize can be awarded to the winner of the tournament, with lesser prizes going to the content providers of second-place, third-place, etc. videos. The prizes can be cash, digital currency that is convertible to cash or goods or otherwise usable on the platform, or goods. Alternatively, the prizes can be nontangible items, such as publicity, social-influence, Leaderboard standings, or exclusive invitation to contests. Each stage of a contest can provide prizes for success specific to that stage.

As the winners are determined, at least in part, by the Quality Review score provided by the Sponsor or Platform-provider, a Popular Vote Award can also be included that is based solely on the number of votes received in the ranking stage. Optionally, a prize can be given to the responsible content provider.

The prizes can be in the form of a digital currency, or “tokens,” that are eligible to be cashed-out at any time by users of the platform. For example, a user may have a balance of any number of tokens associated with their account. An option to withdraw tokens can be presented to the user, and the user can select a denomination (e.g., 25 tokens) to be withdrawn via various payout methods (e.g., transfer of cash to a bank account, conversion to other currency, such as Bitcoin, or purchase of goods).

There may be multiple forms of electronic currency on-platform that can be awarded as prizes. A primary form of electronic currency can include a form in which users can buy value to “top-up” their account, use value to help advance through contests (e.g., by way of “SuperVotes”), and/or to purchase on-platform products. Another form of currency can be an electronic currency where users will not be able to deposit funds to gain value. Such a form can accumulate value through experiential success on-platform and can be used to “wager” or participate in specific contests as well as “cash-out” into legal tender through licensed money transmitting businesses.

### Multi-Entry Tournaments

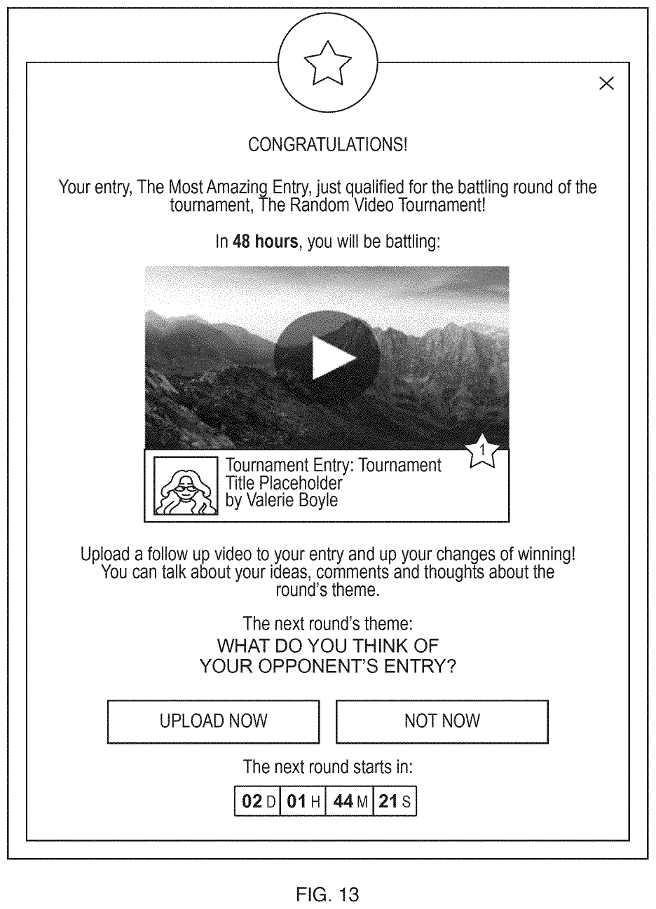

In some embodiments of the tournament stages described above, the highest ranked videos are seeded for the battle stage. As such, a single video submissions may be viewed by users more than once (i.e., at least once in the ranking stage and at least one in the battle stage). In a variation to the standard tournament stages, a multi-entry tournament can be provided. In a multi-entry tournament, upon being ranked in a top subset of videos (e.g., top 16, top 32, etc.), the content provider of a highly-ranked video is then prompted to create and upload a new video. Content providers are also able to view their competitors for the battle stage and customize or personalize their video submissions accordingly. As shown in FIG. 13, upon succeeding at the ranking stage, a user is presented with the timeline constraints surrounding the battle stage, information regarding their seeded component, and a prompt to upload a new video submission. New video submissions for the battle stage may also, optionally, be subject to sponsor and/or platform-provider review to generate a Quality Score for the video. Multiple ranking phases may have different “themes” associated with each phase, such that successful participants upload new video entries directed towards a new theme as they progressively qualify for successive ranking stages.

### Challenge Battle

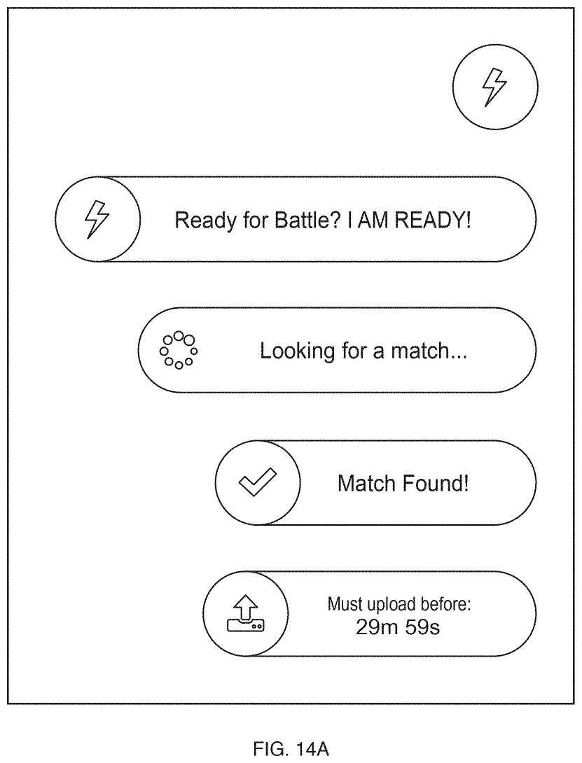

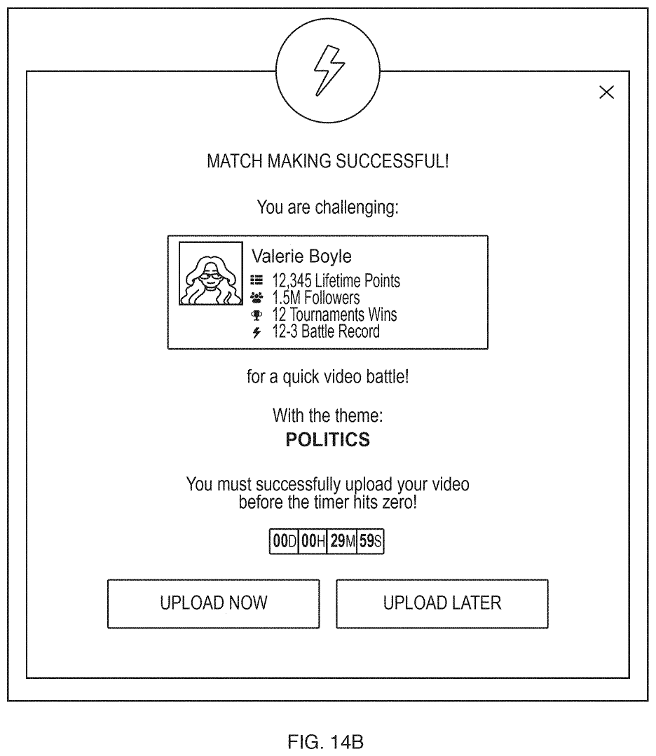

In the tournament stages described above, the ranking and/or battle stages may take several hours, days or weeks to unfold. In another variation to the standard tournament stages, a user can optionally instigate a “real-time” battle, under a challenge mode of the platform. As shown with regard to FIGS. 14A-14B, a user can first alert the platform that he or she is ready for a challenge battle. The platform can search for two, or more, similarly-based opponents (e.g., based on Leaderboard scores, past experience, geographic area, or the like) and identify a match. A theme for the challenge can be generated by the platform, or, alternatively, by a brand sponsor. Each user is then prompted to upload a video within an allotted period of time, (e.g., 30 minutes, 1 hour, 1 day, or the like), or to begin streaming a live video. In this way, Challenge Battles are a variation of the battle portion of the technology described above. In the event that the number of participants in a Challenge Battle does not become a number that works with a single-elimination-style tournament, the Ranking stage, described above, can be used to settle the total number of participants into an amount that works with a single-elimination-style-tournament.

Videos generated or submitted as part of a challenge may or may not receive a quality review score. Quality review scores can optionally be provided by the platform provider, a sponsor, or a panel of selected users. The challenge videos are then made available for a public vote for a period of time. Winners of a challenge battle can receive prizes and/or recognition in a Leaderboard. Challenge battles can appear similar to battles during a tournament, as shown in FIG. 25.

Acceptance into challenge battles can be made conditional on previous success metrics through the platform. For example, a cash prize can be awarded to a winner of challenge battle, provided that their acceptance into the challenge battle was based off previous successes.

Challenge battles can allow contestants to either upload videos, or battle with “LIVE” streaming video relevant to the topic or theme. A user can adjust Battle Settings, such as preferences to submit uploaded video submissions or provide live streaming of video content. Challenge battles can have specific categories to allow contestants to focus on topics they find most relevant to their interests, such as, for example, music, art, or comedy. Configurations for Challenge Battles can be include any number of video(s) above one. For example, a 1 versus 1 battle type can be configured in which two users each upload or stream one video. Multiple video submissions can be configured to compete in an expanded head-to-head-to-head configuration, or expanded bracket of single elimination contests (e.g., 2/4/8/16/32, etc.), or Ranking stage, as described above.

An activation of a Challenge Battle can include publishing a basis for the competition and criteria for entering, notably a ‘wager’ of on-platform-currency that a content-creator places in order to join. The wager can be viewed as an “entry fee,” but in some embodiments, the cost associated with the entry fee is not of a tangible value or legal tender. The cost can be an on-platform currency that is awarded through experiential success on platform. In this form of contest, users opt to wager their currency and battle against one another. Video submissions for these kinds of contests can undergo an optional review process by sponsor where they are scored based on mechanics established by sponsor. There may be multiple sponsors assigned to each contest. Assuming approval of the sponsor(s), video submissions can then undergo a review process by the platform in which the videos are scored and, for example, the videos may be scanned by a facial-recognition module to verify that the submission has been made by a person associated with the user account. The order of approval can be adjusted. For example, the tournament platform can be the first or last step in approval of the content. Either a sponsor or the tournament platform may reject the content. Content may be automatically rejected if the content does not pass facial-recognition approval from the account creator. Upon approval by all parties, a challenge battle contest initiates.

A tournament can option to turn off scoring by the platform and/or sponsor, allowing submitted content to immediately qualify for a tournament. Additionally, a challenge battle can have a panel of selected users on-platform tasked to score each entry. Wager by content-providers may be deducted from the content creators' accounts prior to approval or after approval. The tournament can assume the form of a series of contests between video submissions, with each video submitted being assigned scored by tournament platform and/or sponsor(s) that when published, allow votes to be received from internet audience. The voting of the video audience, in conjunction with the optional scores by the tournament platform and/or sponsor(s) determine the success of an entry versus its competition in-contest. The winner is provided a compensation amount and their wager is returned to them. The loser has their wager claimed by the platform. The platform can optionally allow content creators with no available on-platform-currency to join contests where a wager is required. The platform can optionally take a cut, or rake, of the total prize awarded to the winner.

### Production Battles

Production battles are a type of battle in which the actual contest is filmed on a set, similar to a network television or sporting event. The set can be provided by, for example, a sponsor. As a result, content providers are not battling remotely throughout the world but are on a production-set in a centralized location. The challenge battle can optionally occur in a single video, rather than side-by-side videos, similar to a mixed martial arts (MMA) fight on network television. The production battle can be a live production (e.g., involve live video streaming) or a previously filmed production.

Unlike boxing, MMA, modeling, or pageant events on network TV, due to the internet's ability to watch and instantly interact, the winners can be determined by scoring mechanics that include platform, brand sponsor, and public vote. This means that fans watching, for example, an MMA event can actually be able to dictate the winning fighter. A production battle can include one video with side by side profile/bio information for each of the two contestants/content-providers, and a user of the platform is able to vote for the content provider that they want to advance.

### Social Battles

In another variation to a standard tournament, a user can optionally instigate a social battle, as shown in FIGS. 23A-B. The user can create their own contest from generic themes, or custom-create a theme. The user, functioning as a sponsor with regard to such a contest, can choose other configurations for the contest.

Videos generated or submitted as part of a social battle may or may not receive a quality review score. Quality review scores, if included, can be provided by the platform provider, a sponsor, or a sponsor of selected users. The social battle can then be made available for public or private voting, such as through invitation to specific users or circulation of customized URL. Winners of a social battle can receive prizes and/or recognition, such as in a Leaderboard.

Acceptance, viewership, and/or voting privileges can each be made exclusive through invitation only.

### Supervotes

Generally, each user voting in a contest has a voting power that is equal to that of all other users. However, with a supervote option, users may be able to purchase additional voting power, enabling their votes to constitute supervotes. Supervotes can be applied to ranking stages, battle stages, or both. Supervotes can also be allowed in Challenge Battles and Production Battles.

During an example battle stage, a user is presented with a vote button beneath each video, as shown in FIG. 15. Upon selecting the vote button beneath the video that the user wishes to vote for, a prompt may appear for supervote options. In the example shown in FIG. 16, options for +2 or +20 appear, indicating that the user can continue with a “normal” vote of +2, or a supervote of +20, which would carry ten times the voting weight of the normal vote. A supervote selection can cost the user in tokens and/or in requiring the user to complete additional tasks.

Supervoting can require users to spend tokens or other on-platform currency to cast a supervote. Alternatively, supervoting may not require spending money, but rather, require sponsor-driven or platform-driven behavior on the part of the user. A workflow of being presented with a vote, being introduced to a Supervote, and being introduced to possible requirements is shown in FIG. 28. For example, a user may initially choose to vote for Dominic, as shown in FIG. 28, with the voting prompt updating to provide for supervote options. Alternatively, or in addition, a voting requirement, as shown in the third row of FIG. 28, may appear, requiring that the user complete an action for his or her vote or supervote to count. Such behaviors/actions as may be required for supervoting can help to create more accurate user profiles, as well as accomplish marketing objectives relevant to a sponsor's marketing objectives. The actions can be provided through an HTML embedded element at the voting prompt, allowing for customization by the sponsor at this point of interaction with voters Examples of actions include requiring the user to click to be redirected to another page on the platform, to provide information to upgrade an account and/or by providing user verification information, such as a phone number, click a sponsor-chosen Facebook fanpage to “Like” the page, click a sponsor-chosen URL, opt-in to sharing personal data with the sponsor, be introduced to an e-commerce purchase opportunity, follow the sponsor on platform to generate a larger social-influence, watch a sponsor-chosen advertisement and answer questions about user-reaction to the advertisement, install an app (e.g., a sponsor app available at Google Play® or the Apple® store), download a song from the platform or a music-network, confirm user characteristics, such as age, physical location, interests, and/or date of birth, and/or require the user to upload a video of his or herself for verification.

A supervote can also, optionally, negate any timing requirements between votes. For example, following a normal vote, a user may be prevented from voting again for some period of time. However, a supervote may allow the user to resume voting immediately.

### Cashout

The platform can further provide for “cash-out” of a digital value of on-platform rewards into actual currency through a licensed money transmission service. A user's balance is stored on the platform, including value generated through an on-platform accounting system, and a cash-out interface allows users to cash out the balance when they reach a minimum threshold amount.

A platform “e-wallet” can be configured such that a user is not able to top up the balance actual legal tender. Optionally, a balance may be achieved only through experiential success on platform, which can provide for legal “wager” in challenge battle contests and the like.

### User Verification

Fake or “bot” users are often a concern for voting platforms. To combat fake or automated voters, some systems require pre-registration, with user accounts undergoing a quality review or confirmation process. However a new user may be deterred from a system requiring an up-front registration and confirmation process.

Tournament platforms of the present invention can include a tiered confirmation process, with users being provided with a limited amount of voting ability until they overcome each verification step. For example, when a new user to the tournament platform creates an account, the user may be permitted to vote up to a designated number of times (e.g., 5 votes, 10 votes, 20 votes) before being required to verify their phone number.

In some embodiments, upon phone verification, the user enters a second tier of the verification process. The user is provided with a second number of votes before being required to upload a video. The video can be a user profile video or a confirmation video, in which the user provide some identifying indicia, such as showing their face and stating their name, and, optionally, provide other information, such as the day's date. With information provided in the video, platform providers are able to verify their account, such as reviewing their profiles on social media sites to match account information and facial features.

Facial recognition screening of these videos can also be performed to determine if there are matches to other accounts on the platform. This can reduce multiple accounts created by the same entity and reduce voter fraud.

In some embodiments, upon video entry, the user enters a third tier of the verification process. In the third tier, an ongoing review process can continue, where the user is blocked upon a flag of suspicious activity, or when, after a period of time (e.g., one month, six months, or one year) or a number of votes, the user must upload a new profile or confirmation video. Requiring a user to upload a new profile video can advantageously provide the platform with strengthened facial recognition abilities by having multiple videos of the user available. The repeated requests to periodically upload new profile videos can serve as a blocking function to fake or bot voters and inconvenience other individuals who are not legitimate account holders.

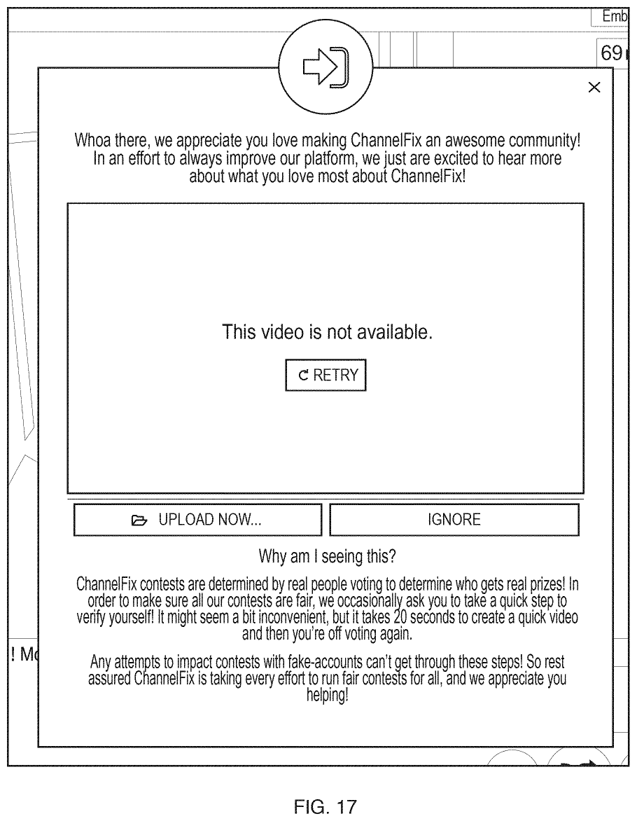

For example, as shown in FIG. 17, upon exhausting a number of votes or a period of time from either the first or second tiers of the user verification process, a user can be presented with a prompt informing them that they are unable to view or vote on more videos without first uploading a profile/confirmation video. As shown in FIG. 17, the video may be prevented from appearing, with the user being prompted to upload a video in order to continue viewing videos.

Alternatively, or in addition, the inclusion of a user's face in a video submission can be requirement to participate in a tournament or a league. Requiring each user to show his or her face in submitted content can confirm the legitimacy of the entry and assure that it was created and uploaded y the person on file for a user account. The inclusion of a user's face, or other identifying indicia, such as a body part, article of clothing, or voice, can allow viewers to establish a connection to that user in the league, thereby building a league of value with recognizable “celebrity” users and curtail the use of misappropriated video submissions.

Additionally, by asking a user in the voting process to confirm information such as gender, location, interests, date of birth, and/or by requiring the user to upload an image or video of his or herself, the platform can generate a social graph, using machine learning to detect and steer inconsistent users into further levels of verification and/or account restriction.

### Tournament Activation

Some examples of activating a tournament competition follow. The contest creator, or sponsor, can be presented with list of call to action videos stored in a database. The creator can select from the existing call to action videos or provide his/her own and that will create a new tournament instance in the database with the selected call to action video and the creator as the owner. Additionally, if the contest creator does not have video capabilities, they can upload a picture that will serve as an image of the contest. In the event of running a Challenge Battle, a contest creator can offer video, images, links to outside web pages, and/or written “themes/topics” for contestants. In the event of a Production Battle, the contest creator can upload the content, or stream the event, as there may be no “call-to-action” for outside participants since it is a “closed” event.

The contest creator can then select from the existing prize packages that are available in the database or provide his/her own custom prize package for the tournament. A connection between the newly created tournament and the selected prize package is then created in the database. The contest creator can also optionally select users to invite in his/her tournament and optionally reward them when their content gets accepted.

Then, the contest creator can be presented with a front end scoring-metric that can be manipulated to assign a “weight” to each party—in many configurations—that the Brand Sponsor wants involved in the dynamic scoring algorithm for the scoring of the contest. Each of these “weights” can then be stored within a database that becomes a metric in the scoring algorithm for each entry uploaded and approved for this contest. For example, the “weight” of each party, and subsequent values scored by platform, brand sponsor, public voting, and/or any additional parties, ultimately decides the scoring criteria for success in the contest by participants.

Additionally, each contest creator can create an advert—e.g., comprising a title, picture and/or video, description, and/or URL. The advert is stored in a database and automatically generated and visually-placed on the detailed front-end pages of the Brand Sponsored contest. These adverts can automatically track impressions and clicks and be relayed back to the brand-sponsor.

Once all the information relevant to the tournaments is completed, the administrator can review the tournaments and decide whether to accept or reject the tournament. If the administrator rejects the tournament he/she may provide a reason for it. The creator will then be notified that his tournament was rejected and can see the reason why it was rejected. The creator can optionally perform edits to the tournament. If the tournament is accepted, it can trigger a signal that creates a new widget in the feed and the browsing page making the tournament accessible to users. The tournament creator can also be notified that his tournament was accepted and all invited users can also be notified that they are invited to participate in this brand new tournament.

### Video Submission Receipt

Examples of video submission procedures follow. In some embodiments, an entry is electronically uploaded via a device (e.g., mobile device, computer, laptop, or tablet) and submitted to the platform database during the open stage of a tournament or the early stage of ranking for some tournaments. This content is stored into cloud storage infrastructure as raw video file and a reference to it is stored in the platform database. The content is run through an encoder that creates copies of the video in different file formats and different resolution(s) so that it can be viewed in multiple devices in manageable file sizes. These transcoded versions of video files may or may not be hashed out with a watermark based on the specifics of the sponsored contest. These transcoded video files—e.g., in mp4 and/or webm formats—are then served in the platform via Content Distribution Network (CDN) so that a sponsor and/or the public may see the video from a fast and reliable source that allows faster buffering and visual-playback-performance. These transcoded videos can then go through the process of platform and/or sponsor review, in either order. For each sponsor (there may be multiple sponsors for a given tournament), each piece of content is showcased in the sponsor's “approve/review online portal.” A rejected video issues a rejection signal back to the server which relays a notification to the content-creator such that they see the rejected status of their entry via their online portal and the rejection of their video content from eligibility or showcase in the Brand Sponsored contest. When a sponsor views an entry for a minimum amount or time or duration—e.g., seconds, minutes, or an entire duration of the video clips—and chooses to approve the video, the approval signal is sent to our database which relays an approval signal which may or may not require an expert-review score based upon the objective criteria of the sponsored contest. If there is an “acceptance fee” to be paid for including this video in a sponsor's content, the brand sponsor may need to pay the “acceptance fee” before full-approval of entry or have the cost of the acceptance added to a bill to be settled at a later time. Either before or after the sponsor review, each piece of content goes through a platform review, which may or may not require an expert-review score based upon the objective criteria of the sponsored contest and objective platform mechanics. The platform may assign an “acceptance” fee to a piece of content that a brand sponsor will need to pay for acceptance into their contest if the video-entry is approved. Subsequently, this video signal can be relayed to the platform for a facial-recognition detection wherein platform confirms that the registered user—and video content creator/uploader—is present in the video.

### Content Provider Compensation

Examples of content provider compensation procedures follow. In some embodiments, an approved video (e.g., by brand-sponsor and/or platform provider and/or other components to an expert-rating-equation) with an acceptable review score and/or an acceptable aggregate review score and/or standard acceptance into a contest, may be eligible for compensation on the platform, for example, in the form of tokens, e-currency, coupons, and/or brand-delivered-merchandise. An aggregate quality review score can be determined by taking the weight of each voting party and computing the ‘aggregated quality review score’ using the following, or similar, formulas: ([Brand-Sponsor-Weight*Quality Review Score]+(Platform-Sponsor-Weight*Quality Review Score]+[Additional Sponsor Weight*Quality Review Score)/Total Number of Components; or (Component Weight*[Quality Review Score/Perfect Quality Review Score])+(Component Weight*[Number of Public Votes/Number of Votes for Entry in #1 Position of Round).

When an entry is approved it can trigger a signal that notifies the content creator that his/her entry was accepted and the signal can also trigger the platform to check if the tournament to which the entry belongs to gives compensation to accepted entries. If the tournament does give compensation for accepted entries, the platform creates a transaction for the content creator containing data about the compensation and the entry that was accepted and stores it in the database. The compensation can be in the form of tokens, e-currency, coupons, and/or brand-delivered-merchandise. If the compensation is in tokens, a transaction can be automatically fulfilled by the platform and the content creator can receive the tokens right away. Compensations can also be given at subsequent stages of the tournament and/or upon completion of the tournament.

### Video Publication

Examples of video publication procedures follow. In some embodiments, for the Ranking stage, the platform filters out rejected submissions and visually presents all approved video submissions from the database in a list, ranked by the videos' aforementioned scores in decreasing order. A countdown timer is also displayed indicating the amount of time left for “open-voting-time” before the next stage of the tournament commences, based on what is stored in the database during the creation of the tournament. As each tournament is created with a set number of submissions that can move on to the next stage, a number of submissions that fall below a cut-off are visually distinguished from the submissions that are currently qualifying, e.g., within the cut-off.

The ranking of the approved video submissions on the list automatically updates as the users vote, based on real-time computation that takes into account the review-score by platform, and/or review-score by the sponsor(s), and/or popular-voting by the public, and the “weight” of each party. This dynamic scoring algorithm, which depends on the configurations previously set during the creation of the tournament, is specific to each tournament.

This computation and the resulting rankings then set into motion the “seeding” of the list of video submissions from Ranking stage. When the countdown timer hits zero, the video submissions that qualify by being above the aforementioned cut-off are automatically entered into the Battling phase. In the Battling phase, these video submissions battle against one another in a series of single-elimination contests until winner(s) are determined.

Voting

Examples of voting procedures follow. In some embodiments, a user wishes to vote for a contest and initiates a vote request. This signal is sent to the platform to verify that the user is logged in. If a user is not logged in, they are sent a pop-up to verify login. Upon successful login, back-end of the platform processes the user status of this account type and, upon recognizing what status of user they are, assure the weight and capacity of their voting ability is in line with their user-standing on platform. As such, when user goes to click a VOTE button he or she sees a voting weight and/or voting capacity that is dependent on his or her user status. If a user has not completed tiered-sets-of-tasks to verify the authenticity of their account, a user may be stopped and forced to submit documentation, answer questions, perform other verification, or upload an image/video to further verify their status and authorized usage of the account. By this action, the platform can extract information about the user to build a user profile and verify authenticity of the user account. In the initial stages of voting, a user may be asked t complete simple questions before their vote counts, such as, for example: “What is your gender?”, “Where are you located?”, “What are your interests?”, and “What is your Date of Birth?” Using this information, the platform is able to build a profile of the user that is valuable, not only for marketing information, but to build a visual expectation of the user. By building a social graph of the user based upon their submissions to these questions, the platform can thus use machine-learning and/or facial-detection and analysis to validate the user's profile.

By ultimately forcing users to upload videos of themselves to continue voting, requiring that users state their names and optionally, other information, such as the date, and matching this information through facial-recognition detection, the backend of the platform can begin to build a storage of visual assets to further improve and match users' identities in further uploads. The visual upload can be matched or compared to the data pulled from introductory questions to further validate the authenticity of the user's profile. The backend of the platform can, accordingly, filter out illegitimate account users through continued evolving and improving facial-recognition and detection, allowing results of contests to be fair and determined by real netizens instead of bot or automated accounts. Content-providers may be prohibited from voting for their own content, or, in addition, for content in any of the contests (both challenge battles and tournaments) in which they have participated.

### Ranking and Battling Stages

Examples of procedures for determining a winning content provider follow. In some embodiments, a tournament includes two stages in which users can vote. These stages can be modular, with a tournament including one or both stages, or multiples of each stage. A contest requires that at least one of the stages happens at least once. The first stage is the Ranking stage. During the ranking stage, users can vote for entries until the timer for the stage hits zero. When the timer hits zero the score of each of the qualified entries can be computed using the following, or similar, formulas: Score=[(Platform Review Score/Perfect Platform Review Score×Platform Review Score Weight)+(Entry Votes/Total Entry Votes×Received Votes Weight)+(Brand Sponsor review Score/Perfect Brand Sponsor Review Score×Brand Sponsor Review Weight)+(other addition parties review score calculation)]×100, or in exchange, Score=[(Platform Review Score/Perfect Platform Review Score×Platform Review Score Weight)+(Entry Votes/Number of Votes for Entry in #1 Position of Round×Received Votes Weight)+(Brand Sponsor review Score/Perfect Brand Sponsor Review Score×Brand Sponsor Review Weight)+(other addition parties review score calculation)]×100 wherein the sum of all weights is one. Videos can also be sorted in Ranking based on Public Voting results, Sponsor review score, and/or platform review score. Or any possible configuration therein.

The accepted entries are then ordered based on their scores, with the highest scoring entry first. In some contest configurations, the ranking stage may be the only stage, and a winner is decided based upon the highest scoring entry. In other configurations of a contest, the position of the entry in the ordered list serves as the video's preliminary place in the tournament, and/or its introduction to subsequent ranking stages or an initial battling stage. The entries that fall within the cut-off after the countdown timer for the Ranking phase hits zero can then progress to another Ranking stage or a Battling phase.

In the Battling phase, the entries are matched against each other in a series of single elimination contests. The amount of entries in a single elimination contest can be, for example, 2, 4, 8, 16, 32, or 64 entries. The matching of the entries follows a standard format where the top #1 entry battles the top #16 entry, the top #2 entry battles the top #15 entry, and so on. The users can then vote for the entries until the round timer hits zero. Once the timer hits zero, the winners and losers for each match are determined by comparing the scores of the two entries using the formula described above. During the battling phase, only the votes for the current match may be counted when computing the entries' scores. In another configuration, all existing votes, including those form previous stages/contests, can also be counted when computing the entries' scores. The places of the entries that lost are then updated and the places for the entries that won are also updated. The winners then progress to the next round where a new set of matches are again automatically created. This process continues until there is only one match left consisting of two entries. After the final match, the entries are ordered by their place, for example, with the entry having first place being the top entry. The number of winners is determined by the number of prizes for the given tournament. For example, if the tournament has three prizes, then the content creator(s) of the top three entries receive prizes.

Videos can also advance in Battling based entirely on Public Voting results, as well as entirely on Sponsor review score and/or platform review score, or a combination of Public Voting results and Sponsor/Platform review.

The prizes are distributed when the tournament is done and the winners have been determined. The platform can create transactions for each winner, containing information about the prizes the winner won and the entry that won, which are stored in the database. If the prize is in the form of tokens, the transaction can be automatically fulfilled and the winner can receive the tokens right away. The platform can send notifications to winners that they won a prize in the tournament, as well as to the tournament creator (e.g., if there are prizes that were not automatically fulfilled, such as a product by a Brand Sponsor that needs to be shipped). The tournament creator can then mark the transaction as fulfilled once he/she has shipped the prize to the winning content creator and provide tracking information. This can then send a notification to the winning content creator that his prize is on its way with tracking information.

### User Challenges

Examples of procedures for user-challenges follow. In some embodiments, platform users are presented with a user interface (UI) element that can be clicked to mark themselves as available for challenge. Upon indication of availability, the user may be presented with configuration options, including video type, category, number of participants, prize packages, and the like.

Video Type: For example, the challenge can be with live streaming video or an uploaded video. If the user chooses to do upload video, the participants of the challenge can be given a period of time (e.g., 10 minutes, 30 minutes, one hour, one day, etc.) to prepare their content and upload it to the site. If the user chooses to do live video, when a match is found, the user can see a timer (e.g., counting down from 10 seconds, one minute, etc.) indicating when a camera application will open and the video stream will commence using the Real Time Streaming Protocol. On the live stream, a small widget overlay in the camera can showcase the stream of the opponent. Clicking the widget can switch the content, making the small widget contain the camera feed. When the live stream starts, users of the tournament platform can view the live stream challenge with the two live streaming videos side by side. Voting may start after a period of time, after a quality score is set for each video stream by the backend (e.g., platform scoring, sponsor scoring) or both. For example, once a quality score is set for each streaming video by the backend, a signal can be sent to the viewing application and users viewing the live challenge will see the vote button pop right below the videos. For the challenge participants, a small vote button beside small stream widget overlay can also optionally pop-up, allowing the participant to vote for his/her content. The stream can run for a specified duration, and when it is over, the camera app can close and the videos will be displayed side by side with the vote buttons below it. The voting may still continue for a specified duration or may close. Alternatively, the voting can take the form of a race to a specific number of votes. For example, the first user to reach a specified number of votes (e.g., 25, 50, 100, 1000, etc.) is designated as the winner.

Content Category: The user can select what category of content he/she wants the challenge to be about. This is done by having different user pools for each category. A category can multiple themes under it, and the theme for the challenge can be selected randomly.

Number of Participants: A challenge can have any number of participants, such as 2, 4, 8, or 16 participants, depending on user selections. For challenges with more than two participants, the matching can be performed by the platform by matching first two users and keeping the challenge open while the looking for other participants. The challenge can have its own search score, which can be used to select other users to join the challenge.

Users in a Challenge Battle can be “seeded” based on experiential history on the platform and/or, additionally, Leaderboard results and previous results in Challenges. Also a Ranking stage can be created in the event that the amount of accepted participants does not fit into the structure of a single-elimination-tournament.

Prize package: A user can select what prize package he/she wants for the challenge, and the prize package can have a corresponding wager amount. An example is a $4 prize package will require the user to wager $2 so that he can participate in a challenge with this prize package. The platform may limit a user to selecting prize packages with wager values that are less than or equal to the amount the user has in his/her cash wallet. The wager amount can be taken from the user's balance right when the challenge begins and reflect in his/her accounting page. Ones the challenge is finished the winner will get the prize package. In the case of the example, the winner will get $4 in his/her cash wallet making him/her earn a net of $2.

A user's configuration can be stored in a platform database and the platform may match the user with other users who have selected the same or similar configurations. Each combination of configuration options can have its own user pool. When the user hits the user interface (UI) element for finalizing his configuration, he is placed in a pool of users available for challenge with his configuration and the platform will check if there are other uses in the pool with a rank that is in the search scope. Matching contestants to each other can be done, for example, through a search scope that initially starts with a small value that is a difference of 5 ranks. This means that if the user is rank 10, his initial search scope only includes users from rank 5 to 15. As time passes by and no match is found, the search scope increases. Additionally, contestants can be matched randomly by platform, or match contestants based on how closely they activated the UI element to begin the match. When a match is found the platform selects a random theme and stores it along with the users involved in the match in the database. An event is triggered in the front end of the platform that notifies the users that the matchmaking was successful in the form of a popup. The popup allows the users to upload a video related to the theme or prepare for a live steam within a certain period of time. For video upload challenge, the uploaded videos can, optionally, be analyzed, such as a by a sponsor, and given a quality score. When the timer hits 0 a battling tournament will go live and for the live challenge the camera app will open and start streaming the video. The battling tournament detail page can showcase the videos by the challenge participants and users can start voting. For the live battle, the detail page showcases live video streams.

If, during the optional sponsor and/or platform analysis phase, both videos are rejected, the battle may be cancelled. If one user's entry is rejected, the platform may provide a notification and an option to supply an edited video within a given period of time (e.g., 10 minutes, 20 minutes, 30 minutes, 60 minutes). A number of approved entries, rejected entries, and reviewed entries may be maintained at the backend of the platform. If one user's entry is approved and another user's entry is rejected, or if the other user fails to upload or stream a video, the challenge will terminate automatically awarding the user with the approved submitted video the prize.

While user challenges between two users are described for simplicity, user challenges can occur with any number of entries. For example, 2, 4, 8, 16, or 32 entries could be part of a user challenge that result in single elimination rounds of a tournament. Similarly, for example, 3, 5, 6, 7, 9, or 33 entries could result in a Ranking phase, which can reduce and seed participants down into a single-elimination-friendly number, such as 2, 4, 8, 16, or 32. The entries may be each be from a unique user, or multiple entries from single users may be provided.

### Wagering

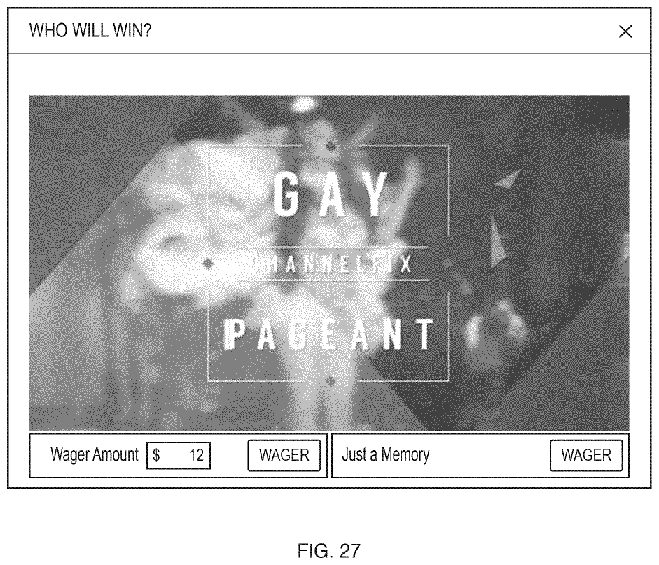

In addition to, or in place of, voting, users may have the ability to wager on a live contest, either a challenge battle or a tournament. For example, in place of a Vote button, as shown in FIG. 12, a Wager buttons may appear beneath one or both videos (FIG. 27), providing the user with the option to wager an amount of on-platform currency on at least one of the video feeds as the anticipated winner or loser. Upon completion of a specific round or contest, wagers can be paid out based on the results of the contest, or stage or phase of the contest. With on-platform currency acquired through experiential success on the tournament platform, such wagering would not be considered gambling. Users may be provided with preset options of amounts to wager, or may indicate an amount.

### Live Streaming

In the case of live video feeds, the receipt of videos for publication can include queuing content-providers and their respective video streams, rather than having videos submitted to the platform and stored in advance of publication. Live video feeds can also include augmented-reality videos and virtual-reality videos.

The tournament platform can be a web application, which can utilize WebRTC to implement live streaming functionality. WebRTC enables web applications to have a peer-to-peer connection through which they can send data directly to each other in real time.

Establishing a WebRTC connection includes a signaling process by which peers provide session descriptions. Session descriptions include information regarding a peer system's capabilities and identification, such as public IP addresses, port numbers, supported codecs and video formats, etc. Session descriptions are transmitted from one peer to the other via an intermediary server called a “signaling server.” Session descriptions can be transmitted in stringified JavaScript Object Notation (JSON) format. In some embodiments, tournament platforms of the present invention include a signaling server. The tournament platform can maintain a registry of installed applications and store configuration files for user systems, such as by a Django application. At the end of the signaling process, each peer is provided with a session description of the other peer(s) (the “remote peer(s)”) to which it is connected.

After the signaling process, peers can start sending data to each other. In the case of video, there is a native browser Application Program Interface (API), such as a MediaStream API, which supports audio and/or video data streaming from the peer devices. The API can be used to access a peer device's camera and microphone, and manipulate, for example, a MediaStream object that represents a flux of audio or video data captured by the peer device. The API further provides the stream of data from these input sources to the platform, via, for example, a Javascript code. The media stream can be added to a WebRTC peer connection so that remote peers can view the stream as well.

The tournament platform can further include an Interactive Connectivity Establishment (ICE) framework, Session Traversal Utilities for NAT (STUN) servers, and/or (Traversal Using Relay for NAT) TURN servers to enable real time connections (RTC), such as through WebRTC. Among other information exchanged during the signaling process is information regarding the network interfaces and ports that will be used for data communication between peers. With this information, an ICE framework can be used to connect peers to each other, such as a streamer (e.g., a content prover) and a viewer (e.g., a voter, a sponsor, or other user), such that a video submission from the streamer is relayed to the viewer. The ICE framework can initially try to connect peers directly, which usually works when peers are in the same network or not behind a Network Address Translation (NAT). In cases when the peers are behind a NAT, a STUN server is used to determine the peers' public addresses and ports so that they can still be connected directly. If direct connection still fails, ICE will then use a TURN server, which will relay the media stream between the peers instead of the peers sending media streams to each other directly. The WebRTC application can be provided with the Uniform Resource Locator (URL) for each of a STUN and TURN server. The ICE framework can automatically determine an appropriate connection type between peers, utilizing the STUN and TURN servers as necessary.

The tournament platform can include or run dedicated STUN and/or TURN servers, such as through a cloud server provider. TURN servers can be run, for example, utilizing open-source software, such as CoTURN. Alternatively, the tournament platform can utilize publically available STUN and/or TURN servers. For example, Google has a publicly available STUN server at stun:stun.l.google.com:19302. As TURN servers relay actual data streams, rather than simply allowing peers to connect to one another directly, servers of tournament platforms of the present invention can be configured to provide for larger bandwidth allocations in order to be capable of streaming large amounts of video content, such as for the parallel streaming of live feeds during a tournament or challenge battle.

Tournament servers of the present invention can include a modified WebRTC application. An issue with the out-of-the-box WebRTC when used in a multi-party setup (e.g., video calling with multiple participants, live streaming with multiple viewers) is that each peer needs to be connected to each other. Media streams are then sent to each remote peer, which is very bandwidth-inefficient, especially via mobile connections. The WebRTC application is also not able to record the streamed media in the backend because it is being sent peer-to-peer. Working around these problems requires reconfiguring the architecture of the WebRTC application. To accommodate side-by-side video streaming from a plurality of users, particularly live streaming, tournament platforms can include a modified WebRTC application that connects all peers to a central server, rather than to each other. This is bandwidth-efficient because data transfer will then only be between a server and the peer, instead of peer-to-peer where data must be sent to every single peer. Another benefit of having a server where all streamed videos pass through is that the server can be setup to record these streamed videos.

### Juxtapose Module

Video players including features particularly suited to simultaneous and dynamic viewing of the videos provided by content providers can be included in the tournament platform. A juxtapose module enables two media elements to be positioned such that they overlap with one another while a separator element is moveable (e.g., slidable) to reveal hide content.

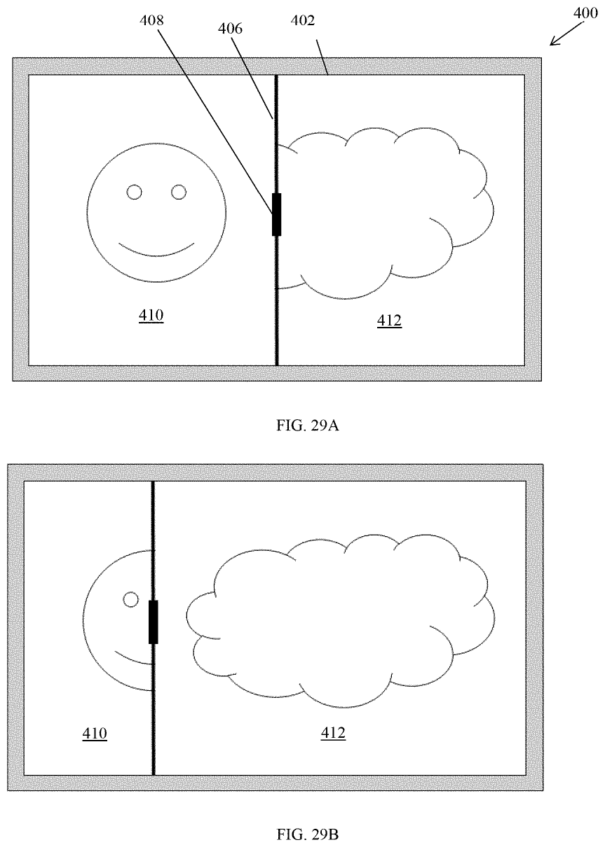

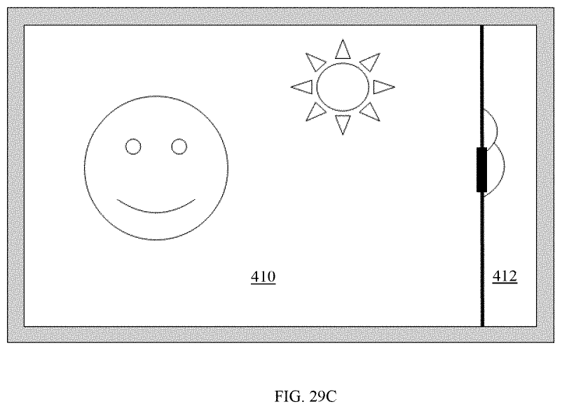

Examples of video players including a juxtapose module are shown in FIG. 28. A diagram of a video player 400 including a juxtapose module is shown in FIGS. 29A-C. The video player 400 includes a juxtapose module with video content 402, which includes a first media element 410 and a second media element 412. The first media element 410 can be a submitted video or a live video stream from a first content provider, while the second media element 412 can be a submitted video or a live video stream from a second content provider. A separator element 406, optionally including a drag handle 408, separates the first and second media elements 410, 412 from one another. As shown in FIG. 29A, the position of the separator element 406 provides for an approximately equal presentation of media elements 410 and 412.

The separator element 406 is slidable to reveal/hide more or less of each of the media elements, as shown in FIGS. 29B and 29C. As such, a viewer (e.g., voter, sponsor) can adjust the position of the separator element 406, such as by clicking and dragging on drag handle 408, to view more or less of the videos provided by the competing content providers.

The tournament platform can include a juxtapose module customized for video. The module can be used to expose a juxtapose function in a web browser's global scope and/or make use of the module in an Asynchronous Module Definition (AMD) environment. Media elements to be displayed in the video player 400 can be assigned attributes such that the media elements are caused to appear as either the left- or right-side contents of the video player.

The juxtapose module can further customize the presentation of video content to a user. For example, the opacity of the each media element can be updated and adjusted based upon separator element position. In addition, or alternatively, the media elements may include sound, and if so, the volume(s) of each of the media elements can be updated and adjusted based upon separator element position. For example, as a user drags separator element 406 towards the left, as shown in FIG. 29B, media element 410 can become less opaque (more transparent) relative to media element 412 and the volume of the sound accompanying media element 412 can increase relative to that of media element 410. Such a video player advantageously allows for users to interactively engage with the video content provided for a tournament or a challenge battle while enabling them to more easily view comparisons between the videos.

The juxtapose module can also provide for features unique to video content. For example, if included, a video control bar for each of the first and second media elements 410, 412 can be dynamically adjusted to fit within a visible width of its side of the video player. Once playback of one of the media elements has stopped, for example, if one media element has a shorter duration than the other or if the user pauses one of the media elements, the juxtapose module can provide for the separator element to automatically move such that the still-playing media element is more exposed relative to the paused or ended media element.

An example of implementing a video player such as video player 400 is provided. A juxtapose module builds upon a base juxtapose widget and enables two video players to be positioned in an overlapping and adjustable manner. Both the juxtapose module and the base juxtapose widget are included in the tournament platform page. The juxtapose module can support both browser global and AMD environments, causing a juxtapose videos function to be exposed in a browser's global scope or invoked in an AMD environment. To render the juxtaposed videos, markup language is included that defines the data-side attributes, with video players being displayed in each of the left and right sides of the widget. The juxtapose videos module further includes configuration objects for adjusting the presentation of video content, as described above.

### Sponsor and Advertisement Management

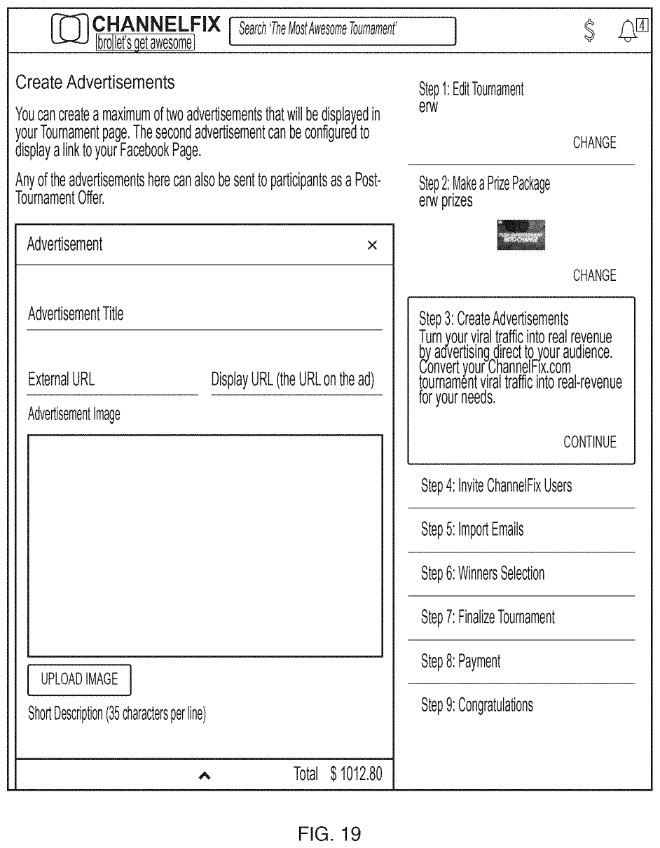

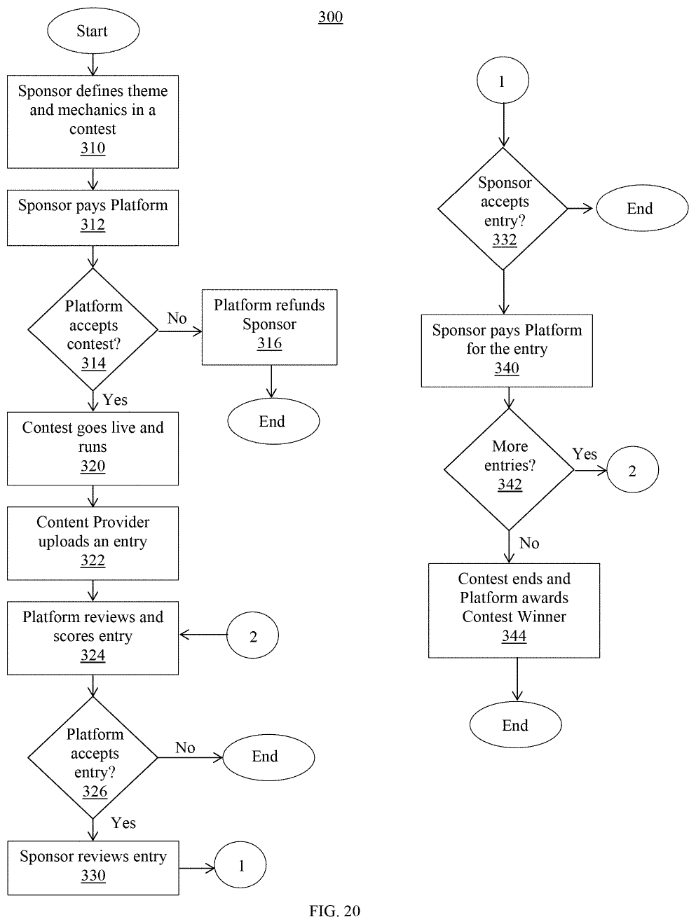

Content sponsors can be provided with tools create a contest (both challenge battles and tournaments) and to manage advertisement options on sponsored contests. An example of a workflow for a tournament is shown in FIG. 20, with a user interface of sponsor-management tools illustrated in FIG. 19.

When a sponsor enters the platform and elects to initiate a challenge or a tournament they are walked through a workflow, including the steps of verifying content information, choosing a type of contest, the theme of the contest, the length and configuration of the stages of the contest (e.g., open, battling, ranking), editing options (e.g., providing title, information, call-to-action content, etc.), designating a prize package, creating advertisements, inviting users, importing emails (e.g., to provide for notifications and/or invitations), choosing voting mechanics for winner determination, editing graphics and rules associated with the contest, and/or selecting whether the contest is for uploaded-video or live stream, and whether the contest will require augmented reality, virtual reality, live steam, and/or uploaded video. Further workflow steps can also appear during the pendency of the contest and/or following the completion of the contest. For example, the steps of selecting winners (e.g., providing sponsor quality review scores, viewing voting results of contests, etc.), finalizing the tournament, providing payment, and congratulating users are also provided to the sponsor.

With regard to creating advertisements, sponsors may elect to include advertisements in their contests. If elected, sponsors can configure advertisement options as shown in FIG. 19. For example, the advertisement module can require a third-party URL to a brand or a good, and other information, such as title, brief description, and image. This information is then provided to an advert-widget, which appears during contests, such as on detailed view pages, or on voting pages. In addition, an advert widget can be integrated with a voting button. For example, in order to have a vote processed, a user may be prompted to click on the advertisement. As such, upon each vote, a click to the brand site is registered.

Sponsors may be charged on a per-click basis, or a variable amount may be docked for each click from a user. The variable amount may be based on, for example, a user's parameters, such as user's previous experience on the platform, age, sex, location, or previous interests on the platform. Brand sponsors may be provided with a budget, such that each click on the advert results in a withdrawal from the advertising budget. As such, for example, when a budget is exhausted (e.g., the charges from a number of clicks have reduced a budget to $0 remaining), voting may return to a state in which no further advertisements appear and/or advertisements are not integrated with voting buttons. Brand sponsors may provide for an overall budget, a daily budget, and/or may top-up their budget if it falls below a threshold amount.

A flowchart illustrating an example of a workflow 300 for a tournament is shown in FIG. 20, with sponsors able to manage content and costs of the tournament. At a start of the process 300, a sponsor, upon entering the platform, arrives at an interface at which the sponsor defines the theme and mechanics of the contest (step 310). The platform can charge the sponsor an initial fee for hosting the contest (step 312) and can, optionally, review the contest mechanics and theme for compliance prior to accepting the contest (step 314). If the platform does not accept the contest, the platform will refund the sponsor (step 316) and the workflow ends. If the platform does accept the contest, the contest is launched by the platform and allowed to run (step 320). Once live, content providers are able to upload videos to the platform (step 322), which can optionally be reviewed by the platform and/or the sponsor. As shown in FIG. 20, the platform may review the content first, provide a score (step 324), and determine (at once or upon review of all submitted content) whether to accept the entry or not (step 326). Following platform review, the sponsor may then review and/or score the entry (step 330). The sponsor may elect to accept or deny the entry (step 332). If accepted by both the platform and the sponsor, the sponsor pays the platform a fee for the content entry (step 340). If further entries are available for review (step 342), the process (steps 324-340) continues until all submitted content is reviewed and either accepted or denied. Once all content submitted is reviewed, the contest ends, with the platform determining a winner and providing an award to the winning content provider (step 344).

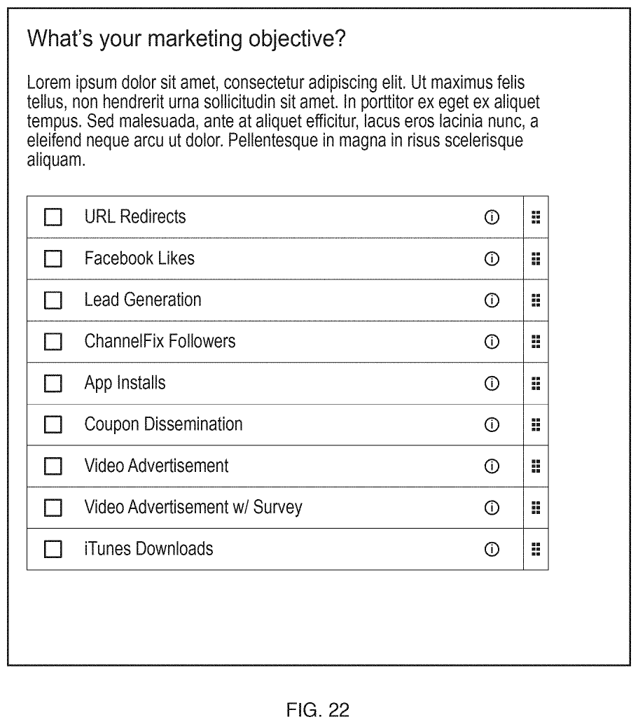

Additional sponsor-management tools can include customizations based on marketing objectives. For example, during contest creation and/or during an account creation for a sponsor, the sponsor may be presented with marketing alternatives to customize the user voting experience. For example, as shown in FIG. 22, a sponsor may select those marketing objectives of interest to them and whether the user-action is to be performed pre- or post-voting. Additionally, the options may be presented in a drag-and-drop format that allows the sponsor to prioritize objectives. The objectives can be, for example, URL redirects, Facebook Likes, Lead Generation, Platform Followers, App Installs, Coupon Dissemination, Video Advertisement, Video Advertisement with Survey, iTunes Downloads, and the like. The marketing objectives can become adverts on corresponding detail-pages of the contest, or pre- and/or post-vote overlays. As such, one viral marketing campaign (e.g., through one on-platform tournament) can serve several marketing objectives and extract a higher number of relevant data-clicks from users that participate in the contest. For example, a user may be presented with any of the following options either before or after voting in order to have their vote count or otherwise help their preferred content advance towards a prize: 1. Click on a URL to Vote; 2. LIKE on Facebook; 3. Agree to give their user information to the brand sponsor (e.g., age, sex, gender, location, interests, etc.); 4. Introduction to commercial product; 5. Follow user on platform; 6. Purchase tokens on platform; 7. Install an app (e.g., a sponsor app available at Google Play® or the Apple® Store); 8. Enter a coupon (e.g., integration with a third party application programming interface (API) to confirm approval of a coupon code, such as, for example a bottle-cap code); 9. Force a Challenge Battle (e.g., in order for vote to be approved, user must engage in a challenge battle on platform); 10. Watch a pre-scroll ad (e.g., for 5 seconds, 15 seconds, etc.); 11. Force upload into another contest; 12. Watch an advert and answer a question, such as a multiple-choice question, correctly; 13. Download music (e.g., locally available on platform, through iTunes®, etc.); 14. Supply user information (e.g., gender, location, interests, date of birth confirmation); and, 15. Verify phone number (e.g., through SMS, phone call, etc.), or any combination thereof. The above-described actions can become cost-per-click or cost-per-impression revenue-generation tools for the platform.

### Crowd-Funding

As participation charges that accompany video submissions may be viewed as consideration in exchange for the chance at a prize in a video tournament, participation charges that go to a central “pool” or “pot” for a winning participant may also be construed as illegal gambling.

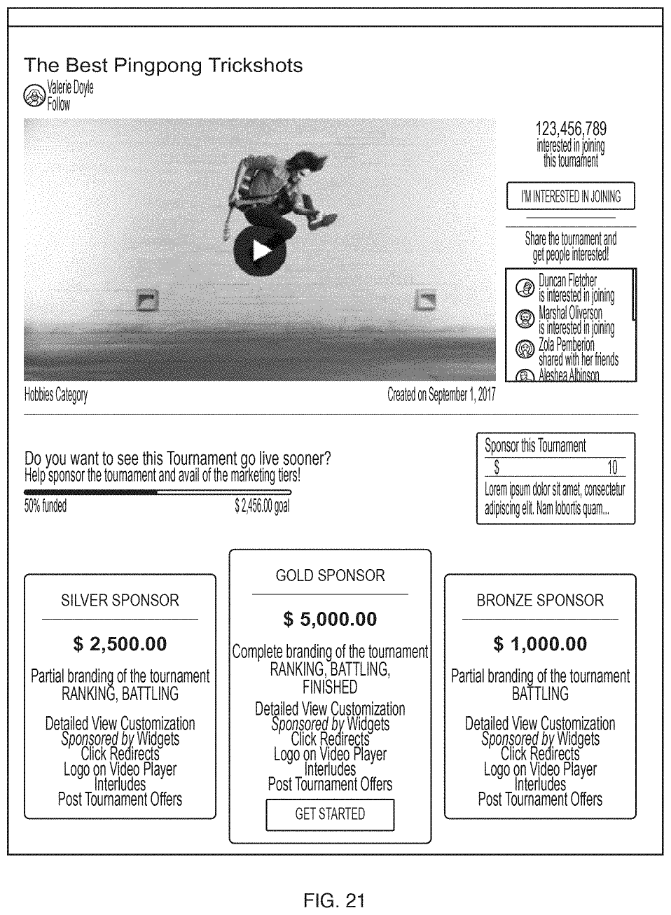

In some embodiments, tournament platforms of the present invention include a pre-tournament, crowd-funding mechanism to support the creation of a tournament or contest. For example, as shown in FIG. 21, a user who wishes to launch a contest creates a themed concept on the tournament platform that includes a crowd-funding goal. Users and/or other individuals may contribute donations towards this goal. The donations do not confer any benefit on the individuals, and a donation does not provide the individual with acceptance into the contest, should the contest launch and the individual decide to participate.

Crowd-funding provides users with the opportunity to establish a collective financial pool for an as-yet uncreated contest, which can be particularly helpful for popular users, or “influencers,” who do not have capital or justification from business ventures to support a prize. Once a crowd-funding goal is met, the platform uses the funds to support a contest. For example, the platform itself may take a percentage of the funds as fees for hosting the contest, the influencer may take a percentage of the funds as, for example, compensation and/or commission for marketing and creation of the contest, and a remaining balance may be converted to prize money for the contest.

### Qualifier Tournaments

While tournaments and contests are described as having a theme, it should be understood that a theme can include diversified subjects. For example, a theme of “best voice” can be broken by region, with different regions competing in qualifier tournaments (e.g., qualifier tournaments for a “Best Voice in SEASia” can be broken down by sub-themes Philippines vs. Korea vs. China vs. Taiwan). A user submitting content can, for example, choose which region to represent when submitting content. Qualifier tournaments may then be conducted for each region, with the top qualifiers (e.g., top 16 videos or content-providers from each country-specific region) being seeded into an expanded 64-seed bracket in which all the regions compete. As another example, a tournament of beverages can be broken down by beverage type, where users can choose between uploading a video about, for example, coffee and/or tea.

### Live Streaming Themes

As described above, two or more live feeds can be broadcast to a plurality of users, the live feeds being video submissions from competing content providers. In some instances, the live video feeds are of the content providers providing a performance, such as singing or dancing. The video submissions of a given contest can be directed to a central theme, with multiple content providers streaming performances in parallel directed to the common, central theme. However, beyond one central theme, a contest may include several themes, which can change over the course of the contest. For example, as content providers stream live video of their performances, the theme can change simultaneously for some or all of the participating content providers. As the themes, or topics, in the stream session change, content providers are expected to adapt their performances. For example, an initial theme may be “bark like a dog,” and the theme can change mid-streaming to “dunk a basketball,” or “sing for 20 seconds.” These themes may be broadcast to the content providers over the tournament platform.

The video streams, while submitted live, may either be broadcast live or may be stored. For example, the live streams may be post-processed and stored on the tournament platform as a video file, where they can undergo a quality review process and/or ranking stages. Alternatively, the live-streaming content providers may each be simultaneously broadcast live to a plurality of voters. Thresholds can be set for progressing to a next round and/or for winning a tournament. A threshold for a number of votes required for each content provider to progress to the next round and a threshold for a number of content providers permitted to enter the next round can be determined by the tournament platform. For example, a contest can include 500 content providing participants, with the first 100 content providers to reach 100 total votes each progressing to a next round.

Live-streaming with changing themes can also be directed to alternative types of contests, such as auditions and interviews. The content providers, which can be, for example, job applicants or people seeking to audition for a role in a film or play, are able to live stream their responses and/or performances in response to a changing theme. In the case of interviewing or auditioning, the theme can be questions provided by an interviewer. The interviewer may either review the entries in real time, or the live-streamed entries can be stored for later review.

### Platform Systems

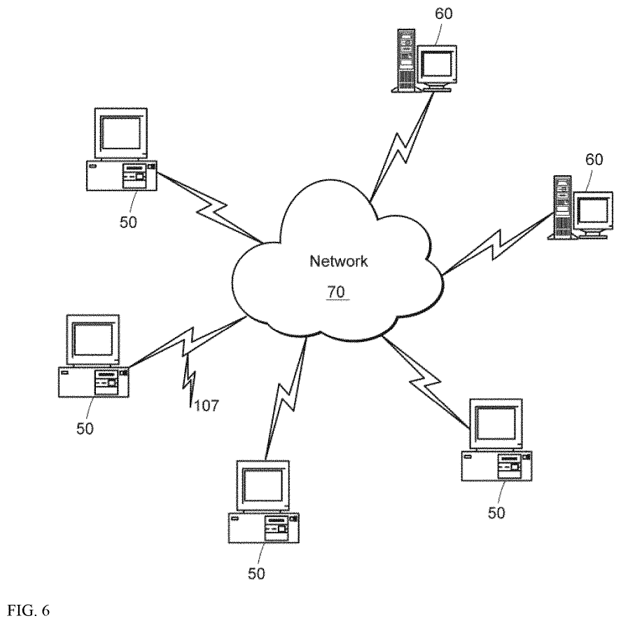

FIG. 6 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

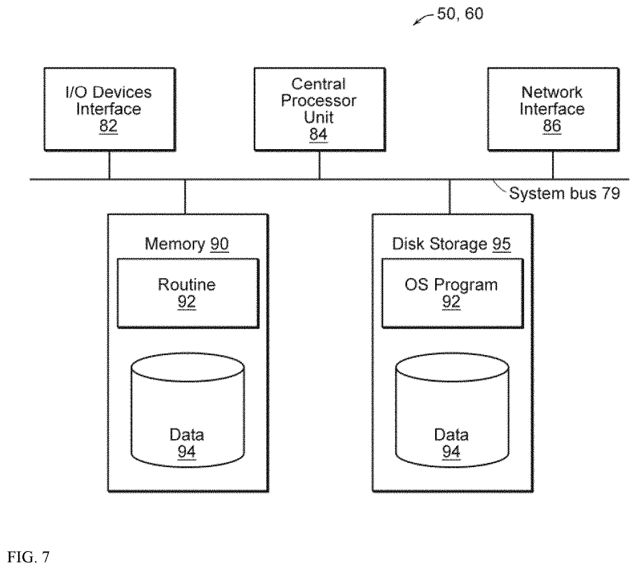

FIG. 7 is a diagram of the internal structure of a computer (e.g., client processor/device 50 or server computers 60) in the computer system of FIG. 6. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6). Memory 90 provides volatile storage for computer software instructions 92 and data 94 used to implement an embodiment of the present invention (e.g., method 200). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In other embodiments, the program product 92 may be implemented as a so called Software as a Service (SaaS), or other installation or communication supporting end-users.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method of presenting video content, comprising:
receiving video content from at least two content providers of a tournament platform;
dynamically rendering the received video content in a juxtapose module, the juxtapose module including a separator element configured to slidably reveal a first video media element of the received video content while hiding a second video media element of the received video content;
streaming the dynamically rendered video content to a plurality of voters of the tournament platform.

2. The method of claim 1, wherein the received video content includes sound and the method further comprises adjusting a volume of the first video media element or the second video media element based upon a position of the separator element.

3. A system for presenting video content, comprising:
a processor configured to:
receive video content from at least two content provers of a tournament platform;
dynamically render the received video content in a juxtapose module, the juxtapose module including a separator element configured to slidably reveal a first video media element of the received video content while hiding a second video media element of the received video content;
stream the dynamically rendered video content to a plurality of voters of the tournament platform.

4. The system of claim 3, wherein the received video content includes sound and the processor is further configured to adjust a volume of the first video media element or the second video media element based upon a position of the separator element.

5. A method of conducting a video competition comprising:
receiving a challenge request from each of at least two content providers;
activating a challenge competition, including publishing a theme for the challenge to the at least two content providers;
receiving video submissions from the at least two content providers;
relaying the received video submissions from the at least two content providers to a plurality of voters, the received video submissions simultaneously presenting to the plurality of voters;
receiving votes from the plurality of voters; and
determining a winning content provider based on the received votes.

6. The method of claim 5 wherein the video submissions are live streaming videos.

7. The method of claim 5 wherein relaying the received video submissions includes establishing real time connections (RTC) between the at least two content providers and the plurality of voters.

8. The method of claim 7 wherein a media stream comprising the received video submissions is transmitted directly from the at least two content providers to the plurality of voters.

9. The method of claim 7 wherein a media stream comprising the received video submissions is relayed through a server from at least two content providers to the plurality of voters.

10. The method of claim 5, further comprising:
displaying the received video submissions to a reviewer;
receiving from the reviewer an acceptance indicator or a rejection indicator for each of the received video submissions.

11. The method of claim 5, further comprising displaying an advertisement at or on a voting button.

12. The method of claim 5, further comprising registering an advertisement click concurrently with receiving each of the votes from the plurality of voters.

13. A system for providing a video comparison platform in a network comprising:
a processor configured to:
receive a challenge request from each of at least two content providers;
activate a challenge competition, including publishing a theme for the challenge to the at least two content providers;
receive video submissions from the at least two content providers;
relay the received video submissions from the at least two content providers to a plurality of voters, the received video submissions simultaneously presenting to the plurality of voters;
receive votes from the plurality of voters; and
determine a winning content provider based on the received votes.

14. The system of claim 13 wherein the video submissions are live streaming videos.

15. The system of claim 13 wherein the processor is further configured to establish real time connections (RTC) between the at least two content providers and the plurality of voters to relay the received video submissions.

16. The system of claim 15 wherein the processor is further configured to facilitate transmission of a directly from the at least two content providers to the plurality of voters.

17. The system of claim 15 wherein the processor is further configured to facilitate relaying through a server a media stream comprising the received video submissions from at least two content providers to the plurality of voters.

18. The system of claim 13, wherein the processor is further configured to:
display the received video submissions to a reviewer;
receive from the reviewer an acceptance indicator or a rejection indicator for each of the received video submissions.

19. The system of claim 13, wherein the processor is further configured to display an advertisement at or on a voting button.

20. The system of claim 13, wherein the processor is further configured to register an advertisement click on receipt of each of the votes from the plurality of voters.

21. The method of claim 5, wherein activating the challenge competition includes selecting the at least two content providers from among a plurality of content providers based on a geographic location of the content providers.

22. The system of claim 13, wherein the processor is further configured to select the at least two content providers from among a plurality of content providers based on a geographic location of the content providers.
